(19) United States
(12) Patent Application Publication
(10) Pub. No.: US 2026/0166886 A1
(43) Pub. Date: Jun. 18, 2026

(54) LIQUID EJECTION DEVICE AND CONTROL METHOD OF LIQUID EJECTION DEVICE

(71) Applicant: SEIKO EPSON CORPORATION, Tokyo (JP)

(72) Inventors: Yuki HIRABAYASHI, SHIOJIRI-SHI (JP); Masaru KOBASHI, MATSUMOTO-SHI (JP); Seiya SATO, MATSUMOTO-SHI (JP)

(21) Appl. No.: 19/415,167

(22) Filed: Dec. 10, 2025

(30) Foreign Application Priority Data
Dec. 13, 2024 (JP) 2024-218499

(51) Int. Cl. B41J 2/175; B41J 2/18; B41J 3/46; B41J 29/46

(52) U.S. Cl. CPC B41J 2/17566; B41J 2/17596; B41J 2/18; B41J 3/46; B41J 29/46

(57) ABSTRACT

A liquid ejection device includes a liquid storage section; a mount section; a transfer section that transfers liquid from a liquid accommodation body mounted on the mount section to the liquid storage section; and a control section, wherein the control section is configured to execute a transfer mode when a first remaining amount of liquid in the liquid accommodation body, becomes equal to or less than a first threshold value, the transfer mode being a mode in which the liquid in the liquid accommodation body is transferred to the liquid storage section until a second remaining amount of liquid in the liquid storage section, reaches a second threshold value and re-execute the transfer mode when, after the transfer mode has been executed and before the liquid accommodation body is replaced, the second remaining amount becomes equal to or less than a third threshold value smaller than the second threshold value.

The present application is based on, and claims priority from JP Application Serial Number 2024-218499, filed Dec. 13, 2024, the disclosure of which is hereby incorporated by reference herein in its entirety.

### BACKGROUND

### 1. Technical Field

The present disclosure relates to a liquid ejection device including a liquid ejection section that ejects liquid and a method of controlling the liquid ejection device.

### 2. Related Art

For example, JP-A-2020-183118 discloses an inkjet printing device as an example of a liquid ejection device, in which ink, as an example of a liquid, is ejected from an inkjet head (an example of a liquid ejection section) to print on a medium. The inkjet printing device includes a printing unit having an inkjet head.

The printing unit includes a sub tank (an example of a liquid storage section) that receives a supply of ink from an ink cartridge (an example of a liquid accommodation body). In the technology disclosed in JP-A-2020-183118, an ink cartridge is ordered when the amount of ink in the ink cartridge reaches the near-end state. Immediately after the order flag is turned on, the printing unit supplies the ink in the ink cartridge to the position of the liquid level sensor in the sub tank. Therefore, the user can replace the ink cartridge with a new one in a state where the remaining amount of ink is considerably less than the near-end state or in an empty state.

However, when a user replaces the ink cartridge after the near-end state, ink may remain in the ink cartridge. For example, in a case where the volume of ink that can be supplied to the sub tank up to the position of the liquid level sensor is smaller than the remaining amount of ink at the time of the near-end state, ink remains in the ink cartridge even if the ink is supplied up to the position of the liquid level sensor. In a case where the user does not replace the ink cartridge for a while after the near-end state, the ink in the sub tank is consumed by printing or cleaning, and thus, although there is a capacity for supplying the ink in the sub tank to the position of the liquid level sensor, there is a concern that the ink cartridge is replaced in a state where the ink remaining amount is large. As described above, there is a concern that the liquid accommodation body is replaced in a state where there is a remaining amount of the liquid even though there is a capacity capable of transferring the liquid in the liquid storage section, and there is room for improvement.

### SUMMARY

A liquid ejection device for solving the above-described problems includes a liquid ejection section configured to eject liquid; a liquid storage section configured to store liquid to be supplied to the liquid ejection section; a mount section on which a liquid accommodation body that contains liquid is mounted; a transfer section that transfers the liquid from the liquid accommodation body to the liquid storage section via the mount section; and a control section, wherein the control section is configured to execute a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and re-execute the transfer mode when, after the transfer mode has been executed and before the liquid accommodation body is replaced, the second remaining amount becomes equal to or less than a third threshold value, which is smaller than the second threshold value.

A control method of a liquid ejection device for solving the above-described problems has a liquid ejection section configured to eject liquid; a liquid storage section configured to store liquid to be supplied to the liquid ejection section; a mount section on which a liquid accommodation body that contains liquid is mounted; a transfer section that transfers the liquid from the liquid accommodation body to the liquid storage section via the mount section, the method including: executing a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and re-executing a transfer mode, after the transfer mode has been executed and before a liquid accommodation body is replaced, when a second remaining amount becomes equal to or less than a third threshold value, which is smaller than a second threshold value.

### BRIEF DESCRIPTION OF THE DRAWINGS

FIG. 1 is a perspective view illustrating a liquid ejection device according to a first embodiment.

FIG. 2 is a schematic side sectional view of a liquid supply unit and a liquid ejection section.

FIG. 3 is a schematic side sectional view illustrating configuration of a coupling section between the liquid accommodation body and the mount section.

FIG. 4 is a schematic side sectional view illustrating a principle of supplying liquid from the liquid accommodation body to the first storage chamber.

FIG. 5 is a schematic side sectional view illustrating a configuration in which a physical sensor detects that a first remaining amount in a liquid accommodation body is equal to or less than a first threshold value.

FIG. 6 is a schematic side view illustrating the principle of the physical sensor.

FIG. 7 is a block diagram illustrating an electrical configuration of the liquid ejection device.

FIG. 8 is a block diagram illustrating a functional configuration of a control section.

FIG. 9 is a schematic diagram illustrating a liquid amount display setting screen.

FIG. 10 is a schematic diagram illustrating a notification screen prompting replacement of the liquid accommodation body.

FIG. 11 is a schematic diagram illustrating a liquid amount information display screen displayed after the execution of the transfer mode.

FIG. 12 is a flow chart showing a transfer mode routine.

FIG. 13 is a schematic side sectional view illustrating the liquid supply unit and the liquid ejection section at the start of the transfer mode.

FIG. 14 is a schematic side sectional view illustrating a state where the second storage chamber is depressurized in the transfer mode.

FIG. 15 is a schematic side sectional view illustrating a state in which liquid is supplied from the liquid accommodation body to the first storage chamber in the transfer mode.

FIG. 16 is a schematic side sectional view illustrating a state where the second storage chamber is opened to atmosphere in the transfer mode.

FIG. 17 is a schematic side sectional view illustrating a state in which the liquid is supplied from the liquid accommodation body to the first storage chamber through the depressurization of the second storage chamber in re-transfer mode.

FIG. 18 is a schematic side sectional view illustrating a state where the second storage chamber is opened to atmosphere in the re-transfer mode.

FIG. 19 is a flowchart illustrating a transfer mode routine in the second embodiment.

FIG. 20 is a schematic side sectional view illustrating a state in which two storage chambers are pressurized in the transfer mode.

FIG. 21 is a schematic side sectional view illustrating a state in which the liquid is supplied from the liquid accommodation body to the first storage chamber in the transfer mode.

FIG. 22 is a schematic side sectional view illustrating a state where two storage chambers are open to atmosphere in the transfer mode.

FIG. 23 is a schematic side sectional view illustrating a configuration in which a physical sensor detects that a first remaining amount in a liquid accommodation body is equal to or less than an end threshold value in a third embodiment.

FIG. 24 is a schematic side sectional view of the liquid supply unit according to the modification when the liquid accommodation body reaches the near-end state and the transfer mode is started.

FIG. 25 is a schematic side sectional view illustrating the liquid supply unit after the transfer mode is executed in the liquid supply unit shown in FIG. 24.

FIG. 26 is a schematic side sectional view illustrating a liquid supply unit and a liquid ejection section different from those in FIGS. 24 and 25.

FIG. 27 is a schematic cross-sectional view illustrating an example of a variable capacity liquid storage section provided in a flow path, which is a modification example different from FIG. 26.

FIG. 28 is a schematic cross-sectional view illustrating a state in which liquid is stored in the variable capacity liquid storage section illustrated in FIG. 26.

### DESCRIPTION OF EMBODIMENTS

### First Embodiment

Hereinafter, a first embodiment of a liquid ejection device will be described with reference to the drawings. The liquid ejection device is, for example, an inkjet printer that performs printing by ejecting ink, which is an example of a liquid, onto a medium such as a paper sheet.

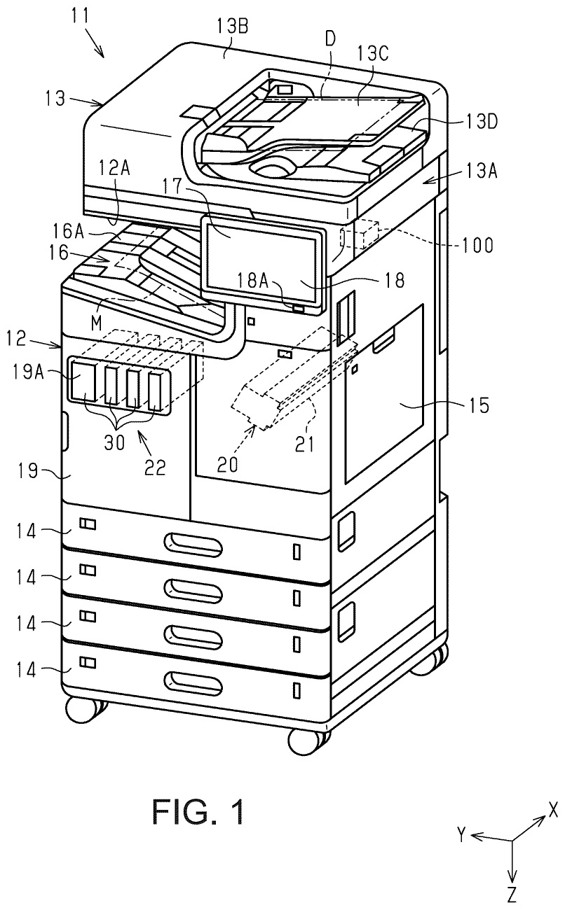

In FIG. 1, it is assumed that a liquid ejection device 11 is placed on a horizontal plane, the direction of gravity is indicated by a Z-axis, and directions along the horizontal plane are indicated by an X-axis and a Y-axis. The X-axis, the Y-axis, and the Z-axis are orthogonal to each other. The X axis indicates the depth direction of the liquid ejection device 11, and the Y axis indicates the width direction of the liquid ejection device 11. The direction parallel to the X axis is also the width direction of the medium M, and thus may be referred to as the width direction X.

### Overall Configuration of Liquid Ejection Device 11

As illustrated in FIG. 1, the liquid ejection device 11 is, for example, a multifunction device. The liquid ejection device 11 includes a device main body 12 having a rectangular parallelepiped shape. The device main body 12 constitutes an inkjet printer. The liquid ejection device 11 includes an image reading section 13 on an upper section of the device main body 12.

The image reading section 13 includes a reading section 13A that reads the document D and an auto document feeding section 13B that feeds the document D. The auto document feeding section 13B feeds the document D placed on a document tray 13C to the reading section 13A, and discharges the document D after being read by the reading section 13A to a discharge tray 13D. In addition, the image reading section 13 also has a flatbed-type reading function, in which the reading section 13A reads a document D placed on the document placement section that becomes exposed when the auto document feeding section 13B, which also serves as the document placement section cover, is opened.

The liquid ejection device 11 may include a medium accommodation section 14 capable of accommodating a plurality of medium M. The medium accommodation section 14 is, for example, a cassette. The medium accommodation section 14 may be provided in one stage or a plurality of stages (for example, four stages in FIG. 1). The medium accommodation section 14 is removably inserted into the lower section of the device main body 12 by sliding in the X direction. For example, medium M having different sizes or types are accommodated in the plurality of medium accommodation section 14. The liquid ejection device 11 may include a medium placement section 15 such as a paper feeding tray on which the medium M can be mounted, in addition to the medium accommodation section 14 as a medium supply section or instead of the medium accommodation section 14.

The liquid ejection device 11 includes a stacker 16 that receives the medium M after printing. The liquid ejection device 11 has a recess section 12A between the device main body 12 and the image reading section 13. The stacker 16 is configured by the recess section 12A and a discharge tray 16A attached to a bottom portion of the recess section 12A. The medium M after being printed and discharged from the device main body 12, is stacked on the discharge tray 16A. The discharge tray 16A is inclined at a predetermined angle such that the downstream side of the discharge direction, where the printed medium M is discharged, is higher than the upstream side.

The liquid ejection device 11 includes a display section 17. The display section 17 may be disposed in a front section of the device main body 12. The display section 17 may be, for example, a touch panel. In this case, an operation section 18 may be configured by a touch panel function of the display section 17. A user can give an instruction to the liquid ejection device 11 by operating the operation section 18. The operation section 18 is operated, for example, when at least one of the selection options on the setting screen displayed on the display section 17 is selected. The display section 17 also functions as a notification section that notifies the user of notification information to be notified to the user. In the present embodiment, when the remaining amount in a liquid accommodation body 30 (to be described later) becomes equal to or less than the near-end state or an ink end state, the liquid ejection device 11 causes the display section 17 functioning as a notification section to notify, for example, information prompting replacement of the liquid accommodation body 30.

The liquid ejection device 11 includes a power switch 18A that is operated to turn on/off the power supply. The operation section 18 may be configured by one or more operation buttons including mechanical switches, separately from the touch panel of the display section 17 or instead of the touch panel.

As illustrated in FIG. 1, the liquid ejection device 11 includes a liquid ejection section 20 capable of ejecting liquid. The liquid ejection section 20 is accommodated in the device main body 12. The liquid ejection section 20 is disposed at a position facing a transport path (not illustrated) through which the medium M is transported in the device main body 12. The liquid ejection section 20 includes an ejection head 21 capable of ejecting liquid. The liquid ejection section 20 is disposed in a predetermined posture in which the ejection head 21 faces the transport path. The medium M is transported along the transport path while maintaining a state in which the width direction of the medium M is parallel to the X axis. Therefore, the ejection head 21 is disposed in a posture parallel to the X axis. The liquid ejection section 20 prints an image or characters on the medium M by ejecting ink, which is an example of a liquid, from the ejection head 21 onto the medium M transported along the transport path.

The liquid ejection device 11 includes a liquid supply unit 22 that supplies liquid (for example, ink) to the liquid ejection section 20. The liquid supply unit 22 includes one or a plurality of (for example, four in FIG. 1) liquid accommodation body 30 mounted in the device main body 12. The liquid accommodation body 30 is, for example, an ink cartridge. The plurality of liquid accommodation body 30 respectively contain inks of a plurality of colors including, for example, black (K), cyan (C), magenta (M), and yellow (Y). The device main body 12 may include a cover 19 at a front section thereof. The liquid accommodation body 30 is housed at a position on the back side of the cover 19. When the user replaces the liquid accommodation body 30, the cover 19 is opened and closed. For example, when the remaining amount of the liquid accommodation body 30 becomes the near-end state, a notification screen for notifying the near-end state is displayed on the display section 17. On the notification screen, information prompting replacement of the liquid accommodation body 30 is notified by designated a color. The user opens the cover 19 to perform a replacement operation of replacing the liquid accommodation body 30 of a designated color with a new one, for example. The cover 19 has a transparent window section 19A through which the liquid accommodation body 30 contained therein can be visually confirmed from the outside.

### Configuration of Liquid Supply Unit 22 and Liquid Ejection Section 20

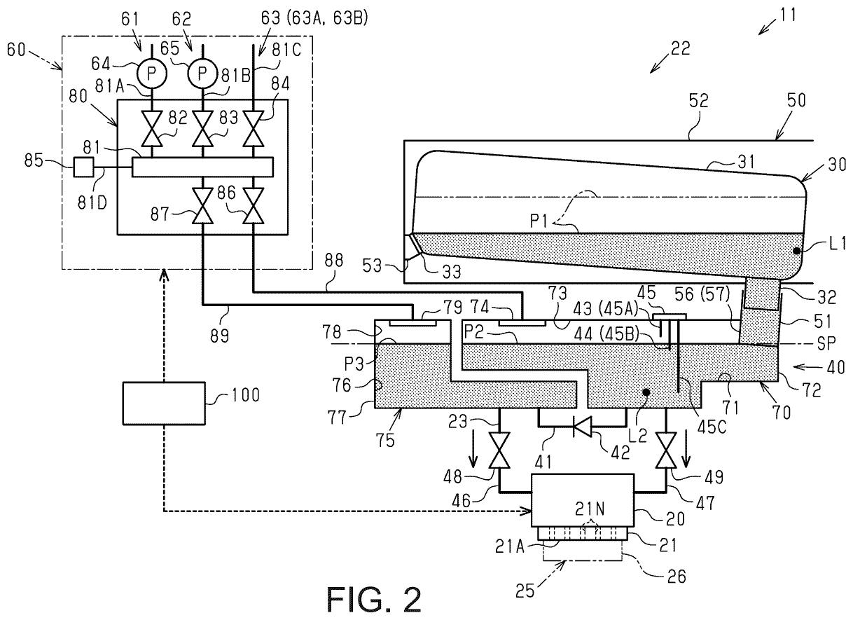

Next, the configurations of the liquid supply unit 22 and the liquid ejection section 20 will be described with reference to FIG. 2. Note that the liquid supply unit 22 is provided for each liquid accommodation body 30, but the basic configuration is substantially the same, and therefore, FIG. 2 illustrates one liquid supply unit 22 including one liquid accommodation body 30.

As illustrated in FIG. 2, the liquid ejection device 11 includes a liquid storage section 40, a mount section 50, a transfer section 60, and a control section 100. Among these, the liquid storage section 40, the mount section 50, and the transfer section 60 constitute the liquid supply unit 22.

The liquid accommodation body 30 includes an accommodation main body 31 (hereinafter, also simply referred to as “main body 31)” and a supply section 32. The main body 31 has a volume capable of storing a predetermined amount of liquid (for example, ink). The main body 31 has, for example, a substantially rectangular parallelepiped shape elongated in one direction. The supply section 32 is provided at, for example, one end section of the liquid accommodation body 30. In the example shown in FIG. 2, the supply section 32 extends from one end section of the main body 31. The supply section 32 may not protrude from the main body 31.

The liquid storage section 40 is configured to be capable of storing the liquid to be supplied to the liquid ejection section 20. The liquid storage section 40 and the liquid ejection section 20 are connected to each other via a supply flow path 46. The liquid in the liquid storage section 40 is supplied to the liquid ejection section 20 via the supply flow path 46. The liquid storage section 40 and the supply flow path 46 will be described in detail later.

The transfer section 60 transfers the liquid from the liquid accommodation body 30 to the liquid storage section 40 via the mount section 50. The transfer section 60 of the present embodiment transfers the liquid from the liquid accommodation body 30 to the liquid storage section 40 by controlling the pressure of the air with respect to the liquid surface in the liquid storage section 40. The details of the transfer section 60 will be described later.

Hereinafter, configurations of the liquid storage section 40, the mount section 50, the liquid ejection section 20, the transfer section 60, and the like will be described with reference to FIG. 2.

### Configuration of Mount Section 50

First, the configuration of the mount section 50 will be described with reference to FIG. 2. As shown in FIG. 2, the liquid accommodation body 30 that contains liquid is mounted on the mount section 50. The mount section 50 causes the mounted liquid accommodation body 30 and the liquid storage section 40 to communicate with each other in a state where the liquid can be supplied. The mount section 50 includes a supplied section 51 extending upward from, for example, a part of the upper portion of the liquid storage section 40.

The mount section 50 may include a case 52 in which the liquid accommodation body 30 is accommodated in a detachable and attachable manner. The case 52 has a guide function for guiding the liquid accommodation body 30. The guide function guides the liquid accommodation body 30 to the mounting position shown in FIG. 2 in the case 52. The liquid accommodation body 30 is horizontally guided to the back along the case 52, and then slightly tilted in the clockwise direction in FIG. 2, whereby the liquid accommodation body 30 is mounted in a state where the supply section 32 is connected to the supplied section 51 of the mount section 50 in the mounting posture shown in FIG. 2.

The liquid accommodation body 30 may have a memory element 33 in the front section thereof. The case 52 may have a coupling terminal 53 at a position corresponding to the memory element 33 on the inner wall of the back. When the liquid accommodation body 30 is in the mounting posture shown in FIG. 2, the terminal of the memory element 33 is electrically connected to the coupling terminal 53 provided on the inner wall of the case 52. The memory element 33 stores ink related information relating to the liquid accommodation body 30. The ink related information includes remaining amount data relating to the remaining amount of liquid for each liquid accommodation body 30. The ink related information includes various types of information such as color information and product number information in addition to the remaining amount data.

When the liquid accommodation body 30 is in the mounted state shown in FIG. 2, the control section 100 can read and write the remaining amount data from and to the memory element 33 by accessing the memory element 33. Note that the details of the configuration in which the liquid accommodation body 30 and the mount section 50 are mounted will be described later.

### Configuration of Liquid Storage Section 40

As illustrated in FIG. 2, the liquid storage section 40 includes a first storage chamber 71, a lead out flow path 41, a second storage chamber 76, a one-way valve 42, and a liquid replenishment section 56.

The first storage chamber 71 stores liquid. The first storage chamber 71 stores the liquid supplied from the liquid accommodation body 30 via the mount section 50. When the liquid accommodation body 30 is a main tank, the first storage chamber 71 is, for example, a sub tank. The first storage chamber 71 is defined inside a box-shaped first housing 72 having a predetermined shape.

The second storage chamber 76 stores liquid. The second storage chamber 76 stores the liquid supplied from the first storage chamber 71. The second storage chamber 76 is, for example, a reservoir tank that temporarily stores the liquid supplied from the first storage chamber 71, which is a sub tank. The second storage chamber 76 is defined inside a box-shaped second housing 77 having a predetermined shape.

The lead out flow path 41 has one end coupled to the first storage chamber 71 and allows the liquid in the first storage chamber 71 to flow out. The second storage chamber 76 is coupled to the other end of the lead out flow path 41 and stores the liquid supplied from the first storage chamber 71.

The one-way valve 42 is provided in the lead out flow path 41. The one-way valve 42 regulates the direction in which the liquid flows through the lead out flow path 41 to one direction from the first storage chamber 71 toward the second storage chamber 76.

The first storage chamber 71 has an air chamber 73 located above the liquid level P2 of the liquid stored in it. A moisture permeable membrane 74 that separates the air chamber 73 from the outside atmosphere is provided in an upper portion of the first housing 72. The first storage chamber 71, the first housing 72, and the moisture permeable membrane 74 constitute, for example, a first storage section 70. The moisture permeable membrane 74 is a film that does not allow liquid to permeate therethrough but allows air to permeate therethrough.

The second storage chamber 76 has an air chamber 78 located above the liquid level P3 of the liquid stored in it. A moisture permeable membrane 79 that separates the air chamber 78 from the outside atmosphere is provided in an upper portion of the second housing 77. The second storage chamber 76, the second housing 77, and the moisture permeable membrane 79 constitute, for example, a second storage section 75. The moisture permeable membrane 79 is a film that does not allow liquid to permeate therethrough but allows air to permeate therethrough. The liquid storage section 40 may include a single housing in which the first housing 72 and the second housing 77 are integrally formed, and a partition wall section that divides the inside of the single housing into two storage chambers 71 and 76.

### Configuration of Liquid Replenishment Section 56

As shown in FIG. 2, the liquid supply unit 22 includes the liquid replenishment section 56 that replenishes the first storage chamber 71 with liquid from the liquid accommodation body 30 via the mount section 50 when the liquid level P2 of the liquid storage section 40 becomes equal to or lower than the reference liquid level SP. The liquid replenishment section 56 according to the present embodiment is configured by, for example, a gas-liquid exchange section 57. When the liquid level P2 becomes equal to or lower than the reference liquid level SP, the gas-liquid exchange section 57 performs gas-liquid exchange in which air on the liquid storage section 40 side is sent to the mount section 50 side and liquid having substantially the same volume as the air is sent from the mount section 50 side to the liquid storage section 40 side. When the liquid level P2 falls below the reference liquid level SP to which the liquid is to be supplied, the gas-liquid exchange section 57 supplies the liquid from the mount section 50 into the liquid storage section 40 by gas-liquid exchange. Therefore, the liquid level P2 in the liquid storage section 40 is substantially maintained at the reference liquid level SP or a position in the vicinity of the lower side thereof. The detailed configuration of the gas-liquid exchange section 57 that functions as the liquid replenishment section 56 will be described later.

### Regarding Configuration for Detecting First Remaining Amount L1 and Second Remaining Amount L2

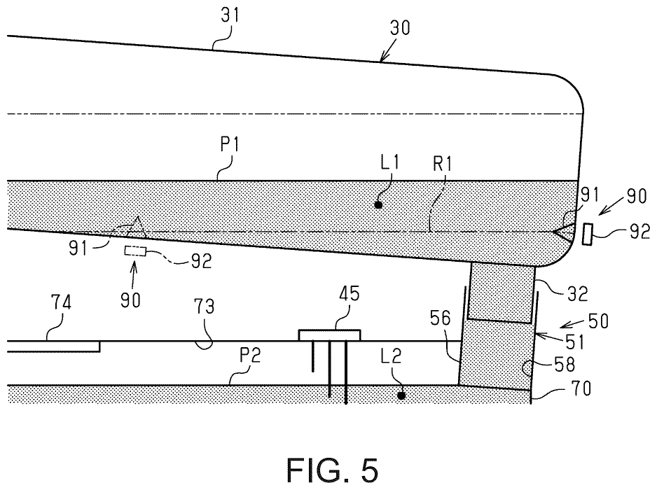

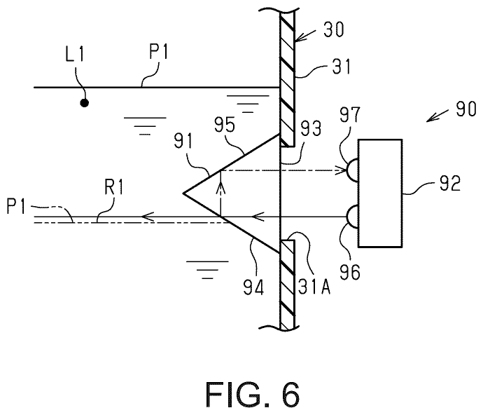

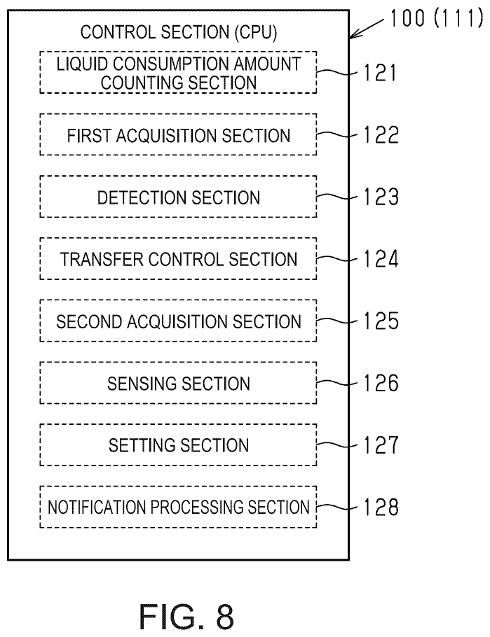

As shown in FIG. 2, the liquid supply unit 22 includes detection sections 90 and 123 (see FIGS. 5 to 8) that detect when the first remaining amount L1 (i.e., the amount of liquid in the liquid accommodation body 30) becomes less than or equal to the first threshold value R1. The detection section 90 may be a physical sensor (see FIGS. 5 and 6) capable of detecting that the first physical remaining amount is equal to or less than the first threshold value R1. The detection section 90 may be a detection section 123 (see FIG. 8) including a soft sensor that detects that the first estimated remaining amount, which is an estimated value of the first remaining amount, is equal to or less than the first threshold value R1. The first threshold value R1 is, for example, a threshold value indicating a remaining amount of the near-end state. That is, the detection section 90 is configured to detect that the first remaining amount L1 has reached the near-end state. However, the first threshold value R1 may correspond to a remaining amount that differs from the near-end state. The first threshold value R1 may be larger or smaller than the remaining amount of the near-end state. The detailed configuration of the detection section 90 will be described later.

As shown in FIG. 2, the liquid supply unit 22 may include a sensing section 43 that physically detects that the second remaining amount L2 has reached the second threshold value R2. The sensing section 43 is not limited to a physical sensor, and may be a sensing section 126 (see FIG. 8) including a soft sensor that detects that the second estimated remaining amount, which is an estimated value of the second remaining amount L2, has reached the second threshold value R2. The second threshold value R2 is, for example, a threshold value that defines an upper limit of the second remaining amount L2. That is, the sensing section 43 is configured to detect that the second remaining amount L2 has reached the upper limit value. The upper limit value is, for example, a threshold value for error detection indicating that the liquid amount of the liquid storage section 40 is abnormal. The upper limit value is, for example, a threshold value set for detecting overflow of the liquid storage section 40. The sensing section 43 also serves as an error sensing section that detects, as an error, that the second remaining amount L2 has become equal to the second threshold value R2. That is, the sensing section 43 also serves as an error sensor. The sensing section 43 according to the present embodiment also serves as an overflow sensor that detects the upper limit value as an overflow. The second threshold value R2 may be an upper limit value of the second remaining amount L2 for preventing liquid leakage from a nozzle 21N due to an excessive water head difference between the liquid storage section 40 and the liquid ejection section 20. In this case, the sensing section 43 also serves as an error sensing section (error sensor) that detects that an excessive water head difference has occurred.

The second threshold value R2 is not limited to the upper limit value, and may be a value corresponding to the remaining amount between the reference liquid level SP and the upper limit value. Here, when the second remaining amount L2 exceeds the upper limit value, there is a possibility that liquid leakage from the nozzle 21N may occur due to an excessive liquid pressure applied to the liquid ejection section 20 due to a water head difference. Therefore, an upper limit value is set. The upper limit value is set to a lower value including a margin in anticipation of safety. Therefore, there is no problem even if the upper limit value is exceeded by the allowable amount of liquid. The detailed configuration of the sensing section 126 including the soft sensor will be described later.

The liquid supply unit 22 may further include a sensing section 44 that detects that the second remaining amount L2 in the liquid storage section 40 has reached a lower limit value. Hereinafter, the sensing section 43 that detects that the second remaining amount L2 has reached the second threshold value R2 is referred to as a first sensing section 43. The sensing section 44 that detects that the second remaining amount L2 has reached the lower limit value is referred to as a second sensing section 44.

As shown in FIG. 2, in the present embodiment, each sensing section 43 and 44 is configured by an electrode type sensor 45 provided in the first storage section 70. The electrode type sensor 45 includes an upper limit electrode 45A, a lower limit electrode 45B, and a reference electrode 45C. The lengths of the electrodes 45A to 45C extending downward are increased stepwise in the order of the upper limit electrode 45A, the lower limit electrode 45B, and the reference electrode 45C. The height of the lower end of the upper limit electrode 45A is located above the reference liquid level SP. The height of the lower end of the lower limit electrode 45B is located below the reference liquid level SP. The lower end of the reference electrode 45C is located below the lower end of the lower limit electrode 45B and above the inner bottom surface of the first housing 72.

The first sensing section 43 is configured by the upper limit electrode 45A and the reference electrode 45C. The potential difference when the liquid level P2 of the second remaining amount L2 is at a height equal to or higher than the lower end of the upper limit electrode 45A is smaller than the potential difference when the liquid level P2 is at a height lower than the lower end of the upper limit electrode 45A. The first sensing section 43 detects that the second remaining amount L2 has reached the upper limit value based on the potential difference between the upper limit electrode 45A and the reference electrode 45C.

The second sensing section 44 is constituted by the lower limit electrode 45B and the reference electrode 45C. The potential difference when the liquid level P2 of the second remaining amount L2 is at a height equal to or higher than the lower end of the lower limit electrode 45B is smaller than the potential difference when the liquid level P2 is at a height lower than the lower end of the lower limit electrode 45B. The second sensing section 44 detects that the second remaining amount L2 has reached the lower limit value based on the potential difference between the lower limit electrode 45B and the reference electrode 45C.

The liquid ejection device 11 may further include the detection section 123 (see FIG. 8) that detects that the first remaining amount L1 of the liquid accommodation body 30 has reached the end state. Hereinafter, the detection section 90 that detects that the first remaining amount L1 is equal to or less than the first threshold value R1 is also referred to as a first detection section 90. The detection section 123 that detects that the first remaining amount L1 has reached the end state is also referred to as a second detection section 123. In the present embodiment, the second detection section 123 is a soft sensor that detects the end state of the liquid accommodation body 30 by estimating it based on the detection result of the first sensing section 43. When the liquid accommodation body 30 is the end state and the liquid is not supplied to the first storage chamber 71, the second remaining amount L2 eventually reaches the lower limit value. The second sensing section 44 may detect the end state of the liquid accommodation body 30 when the lower limit value of the second remaining amount L2 is detected.

Here, the first remaining amount L1 at the end state of the liquid accommodation body 30 is a value equal to or greater than zero and less than the first threshold value R1. The first remaining amount L1 at the end state may be zero or a value larger than zero. Here, a state in which the first remaining amount L1 of the liquid accommodation body 30 is equal to or less than the end threshold value is defined as a state in which the liquid accommodation body 30 is at the end state. The end threshold value is a value equal to or greater than zero and less than the first threshold value R1. When the first threshold value R1 is the near-end state, the end threshold value is a value equal to or greater than zero and less than the near-end threshold value. The end threshold value is zero or an amount beyond which printing is not possible. The near-end state is notified to the user in order to prepare a new liquid accommodation body 30 that can be replaced before the end state.

### Configuration of Supply Flow Path 46 and the Like

As illustrated in FIG. 2, the liquid ejection device 11, according to the present embodiment, includes the supply flow path 46 that supplies the liquid from the liquid storage section 40 toward the liquid ejection section 20, and a recovery flow path 47 that recovers the liquid from the liquid ejection section 20 to the liquid storage section 40. That is, the liquid supply unit 22 includes the supply flow path 46 and the recovery flow path 47 as flow paths that couple the liquid storage section 40 and the liquid ejection section 20.

One end of the supply flow path 46 is coupled to the second storage chamber 76, and the other end of the supply flow path 46 is coupled to the liquid ejection section 20. One end of the recovery flow path 47 is coupled to the first storage chamber 71, and the other end of the recovery flow path 47 is coupled to the liquid ejection section 20. A first flow path valve 48 is provided in the supply flow path 46. The recovery flow path 47 is provided with a second flow path valve 49.

During printing, the two flow path valves 48 and 49 are opened in a state where the first storage chamber 71 and the second storage chamber 76 are open to atmosphere. The liquid in the first storage chamber 71 and the second storage chamber 76 is supplied to the liquid ejection section 20 from both the supply flow path 46 and the recovery flow path 47 as indicated by arrows in FIG. 2. The supply of liquid to the liquid ejection section 20 is carried out by the water head difference between the liquid levels in the first storage chamber 71 and the second storage chamber 76, and the liquid level (meniscus) inside the nozzle 21N of the liquid ejection section 20.

During the maintenance, the second storage chamber 76 is pressurized in a state where the first storage chamber 71 is open to atmosphere. In a state where the two flow path valves 48 and 49 are opened, the liquid in the second storage chamber 76 is collected in the first storage chamber 71 via the liquid ejection section 20. That is, the liquid supplied from the second storage chamber 76 to the liquid ejection section 20 is circulated to be recovered from the liquid ejection section 20 to the first storage chamber 71.

When the liquid is, for example, a pigment ink containing a pigment, the circulation of the liquid suppresses the sedimentation of the pigment in the liquid. In addition, a filter (not illustrated) is provided on the way of a flow path through which the liquid circulates in the liquid storage section 40 or the liquid ejection section 20. By circulating the liquid, foreign matter such as air bubbles in the liquid is removed by the filter.

### Liquid Ejection Section 20 and Maintenance Section 25

The liquid ejection section 20 illustrated in FIG. 2 ejects the liquid supplied from the liquid storage section 40. The liquid ejection section 20 includes the ejection head 21. The ejection head 21 has one or more nozzle 21N. The ejection head 21 has a nozzle opening area 21A in which the nozzle 21N is opened. The liquid ejection section 20 is disposed in a direction in which the nozzle opening area 21A of the ejection head 21 faces the transport path of the medium M. The liquid ejection section 20 prints on the medium M by ejecting ink, which is an example of a liquid, from the nozzle 21N.

The liquid ejection device 11 includes a maintenance section 25 that performs maintenance of the nozzle 21N of the ejection head 21. The maintenance section 25 includes a cap 26 that can come into contact with the nozzle opening area 21A. The cap 26 suppresses thickening of liquid such as ink in the nozzle 21N when printing is not performed under a capping state in which the cap 26 is in contact with the nozzle opening area 21A. The maintenance section 25 performs cleaning as one of the maintenance operations. The cleaning is performed by forcibly discharging the liquid from the nozzle 21N under the capping state of the cap 26 shown in FIG. 2. By the cleaning, foreign matters such as the thickened liquid in the nozzle 21N and air bubbles in the liquid are removed. In addition, the ejection head 21 performs flushing for discharging a liquid such as ink which is not related to printing from the nozzle 21N as one of the maintenances. In this manner, the liquid ejection section 20 consumes the liquid by printing and maintenance such as cleaning and flushing.

### Configuration of Transfer Section 60

As shown in FIG. 2, the transfer section 60 transfers the liquid from the liquid accommodation body 30 to the liquid storage section 40 via the mount section 50. The transfer section 60 has a function of generating a pressure that needs to be applied to the liquid level P2 in the liquid storage section 40 when the liquid is transferred from the liquid accommodation body 30 to the liquid storage section 40. The transfer section 60 has a function of generating a supply pressure for supplying the liquid in the liquid storage section 40 to the liquid ejection section 20.

The transfer section 60 includes a decompression section 61, a pressurizing section 62, and an atmosphere opening section 63. In the present embodiment, the transfer section 60 uses the decompression section 61 and the atmosphere opening section 63 when the transfer mode is executed.

The decompression section 61 decompresses the second storage chamber 76. In the present embodiment, the decompression section 61 is configured to decompress the first storage chamber 71 and the second storage chamber 76 individually. The pressurizing section 62 is configured to individually pressurize the first storage chamber 71 and the second storage chamber 76. The atmosphere opening section 63 is configured to individually open the first storage chamber 71 and the second storage chamber 76 to atmosphere. The atmosphere opening section 63 includes a first atmosphere opening section 63A and a second atmosphere opening section 63B. The first atmosphere opening section 63A opens the first storage chamber 71 to atmosphere. The second atmosphere opening section 63B opens the second storage chamber 76 to atmosphere.

The transfer section 60 includes a selector valve 80, a decompression pump 64 constituting the decompression section 61, and a pressurizing pump 65 constituting the pressurizing section 62.

The selector valve 80 includes a pressure switching mechanism 81, an on/off valves 82 and 83, an atmosphere release valve 84, a first on/off valve 86, and a second on/off valve 87. A decompression flow path 81A, a pressurizing flow path 81B, an atmospheric flow path 81C, a detection flow path 81D, a first air flow path 88, and a second air flow path 89 are connected to the pressure switching mechanism 81.

The decompression flow path 81A is provided with an on/off valve 82 and the decompression pump 64. The pressurizing flow path 81B is provided with an on/off valve 83 and the pressurizing pump 65. The atmosphere release valve 84 is provided in the atmospheric flow path 81C. A pressure sensor 85 is coupled to the detection flow path 81D. The first air flow path 88 is provided with the first on/off valve 86. The second air flow path 89 is provided with the second on/off valve 87.

The pressure switching mechanism 81 includes a plurality of valves (not shown) therein. The pressure switching mechanism 81 individually leads out the pressures introduced by the decompression section 61, the pressurizing section 62, and the atmosphere opening section 63 to the first air flow path 88 and the second air flow path 89.

When the decompression pump 64 is driven in a state where the on/off valve 82 is in the open state and both the on/off valve 83 and the atmosphere release valve 84 are in the closed state, a negative pressure is generated in the pressure switching mechanism 81. The pressure switching mechanism 81 can select a destination of the negative pressure. When the first on/off valve 86 is opened in a state where the negative pressure is generated, the air chamber 73 of the first storage chamber 71 is depressurized. When the second on/off valve 87 is opened in a state where the negative pressure is generated, the air chamber 78 of the second storage chamber 76 is depressurized.

When the pressurizing pump 65 is driven in a state where the on/off valve 83 is open and the on/off valve 82 and the atmosphere release valve 84 are closed, a positive pressure is generated in the pressure switching mechanism 81. The pressure switching mechanism 81 can select a destination of the positive pressure. When the first on/off valve 86 is opened in a state where the positive pressure is generated, the air chamber 73 in the first storage chamber 71 is pressurized. When the second on/off valve 87 is opened in a state where the positive pressure is generated, the air chamber 78 of the second storage chamber 76 is pressurized.

When the atmosphere release valve 84 is in the open state and the on/off valves 82 and 83 is in the closed state, the inside of the pressure switching mechanism 81 is at atmospheric pressure. When the first on/off valve 86 is opened in a state where the pressure in the first storage chamber 71 becomes the atmospheric pressure, the air chamber 73 in the first storage chamber 71 is opened to atmosphere. The atmospheric flow path 81C, the atmosphere release valve 84, the pressure switching mechanism 81, the first air flow path 88, and the first on/off valve 86, which open the inside of the first storage chamber 71 to atmosphere, constitute the first atmosphere opening section 63A.

When the second on/off valve 87 is opened in the state where the pressure in the second storage chamber 76 is equal to the atmospheric pressure, the air chamber 78 of the second storage chamber 76 is opened to atmosphere. The atmospheric flow path 81C, the atmosphere release valve 84, the pressure switching mechanism 81, the second air flow path 89, and the second on/off valve 87, which release the inside of the second storage chamber 76 to atmosphere, constitute the second atmosphere opening section 63B.

The control section 100 controls the liquid ejection section 20, the first flow path valve 48, the second flow path valve 49, and the transfer section 60. When the first remaining amount L1 in the liquid accommodation body 30 becomes equal to or less than the first threshold value R1, the control section 100, according to the present embodiment, executes a transfer mode in which the liquid in the liquid accommodation body 30 is transferred to the liquid storage section 40. In the present embodiment, in the transfer mode, the pressure in the second storage chamber 76 is reduced to the pressure Pn by the decompression section 61 in a state where the first storage chamber 71 is opened to atmosphere by the first atmosphere opening section 63A.

The first atmosphere opening section 63A is configured to open the inside of the first storage chamber 71 to atmosphere. In the first storage chamber 71, the air chamber 73 is formed by a space above the liquid level P2 of the liquid stored in the first storage chamber 71. The first atmosphere opening section 63A has the moisture permeable membrane 74 provided on the upper portion of the first housing 72. The space outside the moisture permeable membrane 74 is configured to communicate with atmosphere.

The second atmosphere opening section 63B is configured to open the inside of the second storage chamber 76 to atmosphere. In the second storage chamber 76, the air chamber 78 is formed by a space above the liquid level P3 of the liquid stored in the second storage chamber 76. The second atmosphere opening section 63B has the moisture permeable membrane 79 provided in an upper portion of the second housing 77. The space outside the moisture permeable membrane 79 is configured to communicate with atmosphere.

Even if the liquid level P2 of the liquid storage section 40 is not equal to or lower than the reference liquid level SP, the transfer section 60 transfers the liquid by causing the liquid replenishment section 56 to replenish the liquid.

The transfer section 60 transfers the liquid from the liquid accommodation body 30 to the liquid storage section 40 via the mount section 50 by adjusting the air pressure in the liquid storage section 40 to lower the liquid level P2 to the reference liquid level SP or lower.

The control section 100 executes the transfer mode by opening the inside of the second storage chamber 76 to atmosphere after causing the transfer section 60 to reduce the pressure inside the second storage chamber 76 to make the liquid level P2 of the first storage chamber 71 equal to or lower than the reference liquid level SP.

### Configuration of Mount Section 50 and Liquid Replenishment Mechanism 56

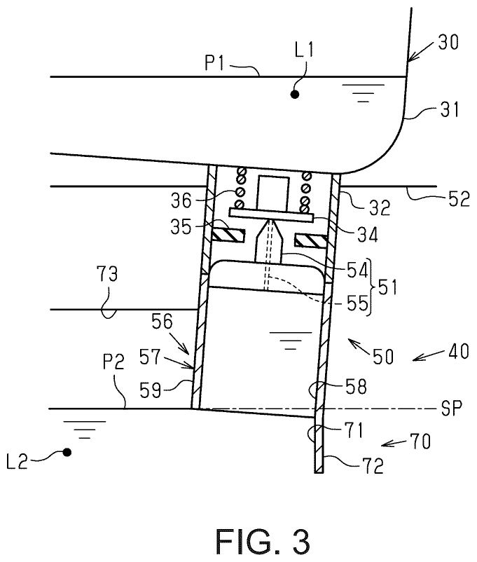

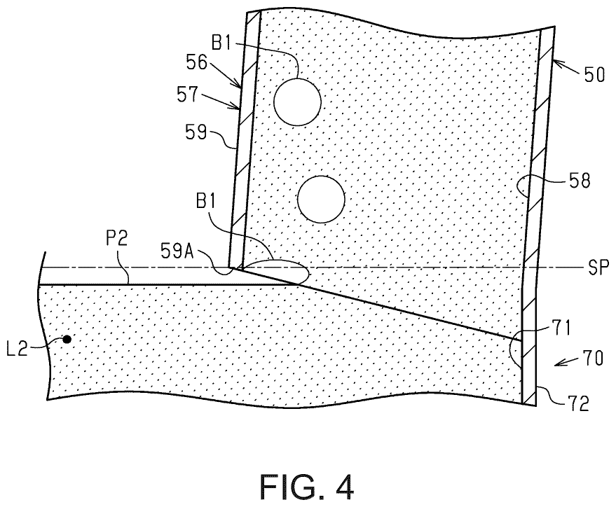

Next, the configuration of the mount section 50 and the liquid replenishment section 56 will be described with reference to FIGS. 3 and 4. As illustrated in FIG. 3, the liquid accommodation body 30 includes a valve body 34, a valve seat 35, and a spring 36 that biases the valve body 34 in a direction in which the valve body 34 is pressed against the valve seat 35, inside the supply section 32.

As shown in FIG. 3, the supplied section 51 of the mount section 50 has a needle-shaped coupled section 54. The coupled section 54 has a communication path 55 penetrating in the axial direction thereof. Before the liquid accommodation body 30 is mounted on the mount section 50, the valve body 34 abuts on the valve seat 35, and thus the supply section 32 is closed. When the liquid accommodation body 30 is mounted on the mount section 50, the coupled section 54 pushes the valve body 34, and thus the valve body 34 and the valve seat 35 are separated from each other. As a result, the supply section 32 are coupled with the supplied section 51 in a communicating state.

A tubular replenishment flow path 58 is formed on the lower side of the supplied section 51. The liquid accommodation body 30 mounted on the mount section 50 is coupled to the liquid storage section 40 via the supplied section 51 and the replenishment flow path 58. The supplied section 51 may be configured such that a member having the coupled section 54 moves relative to the replenishment flow path 58.

The liquid replenishment section 56 according to the present embodiment is configured by, for example, the gas-liquid exchange section 57 that replenishes the liquid by gas-liquid exchange. In the gas-liquid exchange section 57, when the liquid level P2 becomes equal to or lower than the reference liquid level SP, the air in the air chamber 73 on the liquid storage section 40 side is sent to the mount section 50 side, and the liquid having substantially the same volume as the air is sent from the replenishment flow path 58 to the liquid storage section 40 side. The gas-liquid exchange section 57 includes the replenishment flow path 58 and a partition wall section 59 that forms the replenishment flow path 58.

As illustrated in FIG. 4, the liquid level P2 is lowered below the reference liquid level SP due to ink consumption of the liquid ejection section 20 or the like. When the liquid level P2 is lowered below the reference liquid level SP, the air in the air chamber 73 moves to the replenishment flow path 58 side via the lower side of a lower end 59A of the partition wall section 59, and thus the gas-liquid exchange can be performed. In the gas-liquid exchange, the liquid having substantially the same volume as the bubble B1 moves from the replenishment flow path 58 to the first storage chamber 71. That is, the liquid is supplied from the liquid accommodation body 30 to the first storage chamber 71 via the supplied section 51 of the mount section 50. When the liquid level P2 falls below the reference liquid level SP, the gas-liquid exchange section 57 replenishes the liquid from the liquid accommodation body 30 into the liquid storage section 40 by the gas-liquid exchange. Therefore, the liquid level P2 in the liquid storage section 40 is substantially maintained at the reference liquid level SP or a position in the vicinity of the lower side thereof.

### Configuration of Detection Section 90

Next, an example of a configuration of the detection section 90 including a physical sensor will be described with reference to FIGS. 5 and 6. The first detection section 90, which is an example of a detection section, is configured by a physical sensor that detects that the first remaining amount L1 in the liquid accommodation body 30 has reached the first threshold value R1 or less. The first threshold value R1 is, for example, the near-end state.

As illustrated in FIG. 5, the first detection section 90 is configured by a prism 91 provided at a position corresponding to the liquid level height of the first threshold value R1 in the liquid accommodation body 30, and an optical sensor 92. The first detection section 90 may be disposed at a side portion or a bottom portion of the main body 31 as long as the first detection section 90 can detect that the first remaining amount L1 is equal to or less than the first threshold value R1. For example, as shown in FIG. 5, the first detection section 90 may be provided on a side portion of the main body 31. Further, the first detection section 90 indicated by a two-dot chain line in FIG. 5 may be provided at the bottom portion of the main body 31.

As shown in FIG. 6, the liquid accommodation body 30 has a window section 31A at a position corresponding to the liquid level height of the first threshold value R1 in the main body 31. The prism 91 is disposed inside the window section 31A.

The prism 91 has a triangular cross section in a side view as viewed from a direction orthogonal to the paper surface in FIG. 6. The prism 91 has three surfaces 93 to 95 corresponding to the sides of a triangle. The prism 91 is disposed in a posture in which the first surface 93 closes the window section 31A, and faces the optical sensor 92. The second surface 94 and the third surface 95, which are the other two faces of the prism 91, are disposed in a state of being inclined at an acute angle (for example, about 45°) with respect to the direction facing the optical sensor 92.

The optical sensor 92 includes a light emitting section 96 and a light receiving section 97. Before the first remaining amount L1 in the liquid accommodation body 30 reaches the first threshold value R1 (for example, the near-end state), the light incident on the prism 91 from the light emitting section 96 of the optical sensor 92 is transmitted through the prism 91. Therefore, the optical sensor 92 is in the non-detection state when the light reception detection value of the light received by the light receiving section 97 is equal to or less than the detection threshold value. When the first remaining amount L1 in the liquid accommodation body 30 becomes equal to or less than the first threshold value R1, the light from the light emitting section 96 of the optical sensor 92 is reflected by the faces 94 and 95 of the prism 91, and thus the amount of light received by the light receiving section 97 increases. Therefore, the optical sensor 92 is in the detection state when the light reception detection value of the light received by the light receiving section 97 exceeds the detection threshold value. Accordingly, the first detection section 90 detects that the first remaining amount L1 of the liquid accommodation body 30 is equal to or less than the first threshold value R1 by changing from the non-detection state to the detection state. The first detection section 90 according to the present embodiment switches from the non-detection state to the detection state when the first remaining amount L1 of the liquid accommodation body 30 reaches or drops below the near-end state.

### Electrical Configuration of Liquid Ejection Device 11

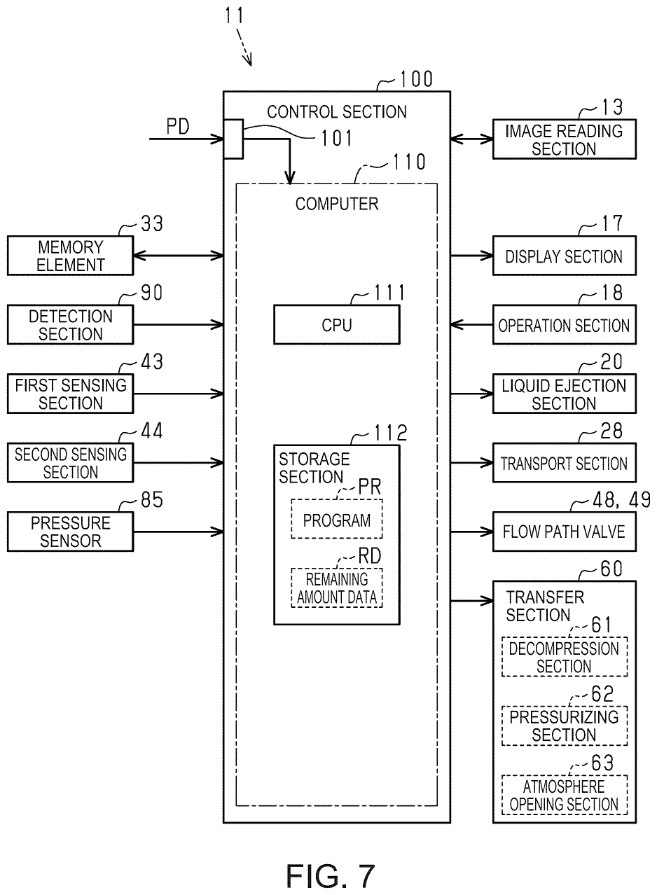

Next, an electrical configuration of the liquid ejection device 11 will be described with reference to FIG. 7. As illustrated in FIG. 7, the liquid ejection device 11 includes the control section 100 described above. The control section 100 comprehensively controls the liquid ejection device 11. The control section 100 can be configured as a circuit including α: one or more processors that execute various processes according to a computer program, β: one or more dedicated hardware circuits that execute at least a part of the various processes, or γ: a combination thereof. The hardware circuit is, for example, an application-specific integrated circuit (ASIC). The processor includes a CPU and a memory section including a memory such as a RAM and a ROM. The memory section stores program codes or instructions configured to cause the CPU to execute processing. Memory that is computer readable medium includes any readable medium that can be accessed by a general-purpose or dedicated computer.

The control section 100 is capable of communicating with a host device (not shown) via a communication interface 101. The control section 100 receives print data PD from the host device.

The image reading section 13, the display section 17, the operation section 18, the liquid ejection section 20, a transport section 28, the flow path valves 48 and 49, and the transfer section 60 are electrically coupled with the control section 100. The control section 100 is communicably coupled to the memory element 33 in a state where the liquid accommodation body 30 is mounted on the mount section 50. The control section 100 is electrically coupled with the detection section 90, the first sensing section 43, the second sensing section 44, and the pressure sensor 85 as a sensor system. The transfer section 60 includes the decompression section 61, the pressurizing section 62, and the atmosphere opening section 63. The control section 100 is capable of individually subjecting the first storage chamber 71 and the second storage chamber 76 to decompression, pressurization, and atmospheric release by controlling the transfer section 60.

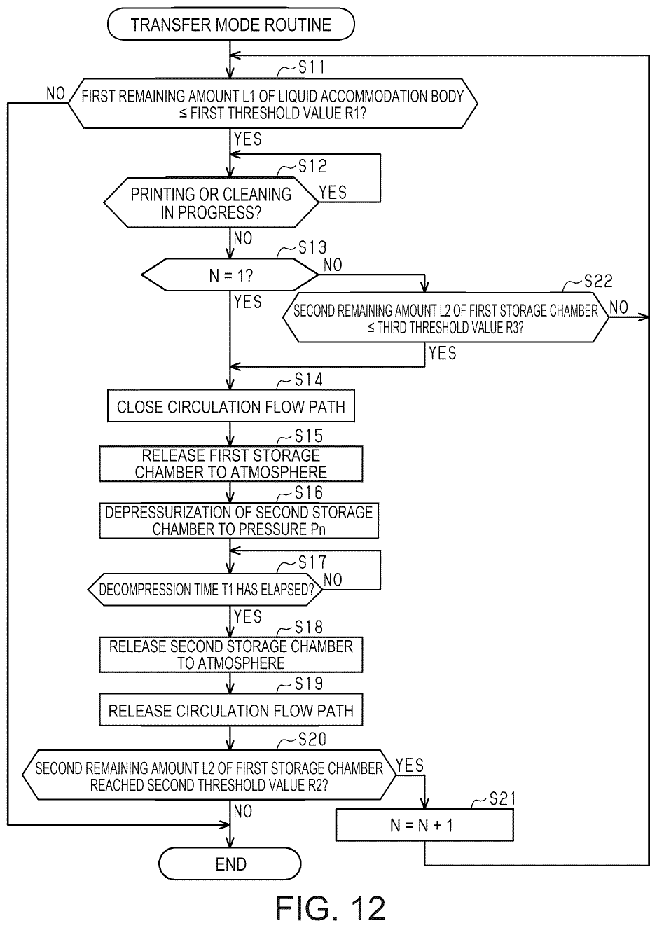

The control section 100 includes a computer 110. The computer 110 includes a CPU 111 and a memory section 112. The memory section 112 stores a program PR and remaining amount data RD. The control section 100 includes various functional units implemented in software by executing the program PR. The program PR includes a transfer mode routine shown in FIG. 12. The control section 100 executes the transfer mode based on a program related to a transfer mode routine shown by a flowchart in FIG. 12. The control section 100 writes the remaining amount data RD read from the memory element 33 into the memory section 112. The control section 100 acquires the liquid consumption amount by the liquid ejection section 20 during printing and cleaning by calculating it based on the print data PD and cleaning information. The control section 100 updates the remaining amount data RD by subtracting the value of the liquid consumption amount from the value of the remaining amount data RD. When the power switch 18A of the operation section 18 is operated to turn off the power source, the control section 100 writes the latest remaining amount data RD in the memory element 33.

### Functional Configuration of Control Section 100

Next, a configuration related to a function provided by the control section 100 (CPU 111) executing the program PR will be described with reference to FIG. 8. As shown in FIG. 8, the control section 100 includes, as a functional configuration formed of software, a liquid consumption amount counting section 121, a first acquisition section 122, the detection section 123, a transfer control section 124, a second acquisition section 125, the sensing section 126, a setting section 127, and a notification processing section 128.

The liquid consumption amount counting section 121 counts the liquid consumption amount of the liquid consumed by the liquid ejection section 20. The liquid consumption amount counting section 121 counts the number of dots of the image data included in the print data PD for each color, thereby counting the liquid consumption amount for each liquid accommodation body 30 of each color. When there is a plurality of types of dot sizes of the printing dots, the liquid consumption amount is counted by counting a multiplication value obtained by multiplying each dot by a coefficient corresponding to the dot size. The liquid consumption amount counting section 121 counts the liquid consumption amount consumed by cleaning based on the cleaning information. The cleaning information is, for example, table data in which the cleaning intensity and the liquid consumption amount consumed by the cleaning at the cleaning intensity are associated with each other. When the cleaning intensity is determined, the liquid consumption amount counting section 121 acquires the liquid consumption amount corresponding to the cleaning intensity with reference to the cleaning information. The liquid consumption amount counting section 121 acquires the liquid consumption amount consumed by the liquid ejection section 20 by counting the liquid consumption amount consumed by printing and the liquid consumption amount consumed by cleaning.

The first acquisition section 122 acquires an estimated value of the first remaining amount L1 of the liquid accommodation body 30 as a first estimated remaining amount. The first acquisition section 122 acquires the first estimated remaining amount by subtracting the liquid consumption amount from the remaining amount data RD.

The detection section 123 is a soft sensor having a detection function similar to that of the detection section 90 which is a physical sensor. The detection section 123 determines whether the first estimated remaining amount is equal to or less than the first threshold value R1, thereby detecting, for example, the near-end state. The first threshold value R1 may be set to a reference value that does not correspond to the near-end state. Note that only one of the detection sections 90 and the detection section 123 may be provided.

The transfer control section 124 controls the transfer section 60. The transfer control section 124 individually adjusts the pressures of the first storage chamber 71 and the second storage chamber 76 by controlling the decompression section 61, the pressurizing section 62, and the atmosphere opening section 63 constituting the transfer section 60. In the present embodiment, when the first remaining amount L1 becomes equal to or less than the first threshold value R1 based on the detection result of the detection section 90 and 123, the transfer control section 124 executes the transfer mode by controlling the decompression section 61 and the atmosphere opening section 63.

The second acquisition section 125 acquires an estimated value of the second remaining amount L2 in the liquid storage section 40 as a second estimated remaining amount. The second acquisition section 125 estimates that the second remaining amount L2 of the liquid storage section 40 before the transfer mode is executed is a liquid amount corresponding to the reference liquid level SP. When the liquid accommodation body 30 is empty and then no more refilling is performed, the second estimated remaining amount is acquired by subtracting the liquid consumption amount from the liquid amount corresponding to the reference liquid level SP. The second acquisition section 125 judges that the replenishment is stopped after the liquid accommodation body 30 is emptied, based on the first estimated remaining amount acquired from the first acquisition section 122.

Here, the amount of liquid transferred in one transfer mode can be estimated from the pressure Pn at the time of depressurization and the decompression time T1. Specifically, the amount of liquid transferred in one transfer mode is determined in advance as a target transfer amount. The pressure Pn and the decompression time T1 during decompression are set so that the transfer amount becomes the target transfer amount. The second acquisition section 125 may estimate the known target transfer amount as the transfer amount of the liquid for one transfer mode. When the transfer mode is executed, the control section 100 decreases the first estimated remaining amount and increases the second estimated remaining amount by the estimated transfer amount of the liquid in the transfer mode. That is, the first acquisition section 122 acquires the first estimated remaining amount immediately after the execution of the transfer mode by decreasing the first estimated remaining amount by the estimated transfer amount of the liquid in the transfer mode. The second acquisition section 125 acquires the second estimated remaining amount immediately after the execution of the transfer mode by increasing the second estimated remaining amount by the estimated transfer amount of the liquid in the transfer mode.

The sensing section 126 is a soft sensor having a detection function similar to that of the sensing section 43 which is a physical sensor. The sensing section 126 detects that the second estimated remaining amount has reached the second threshold value R2. Only one of the sensing sections 43 and the sensing section 126 may be provided.

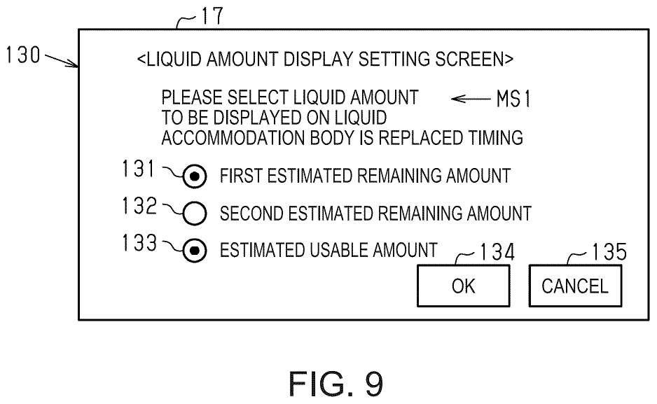

The setting section 127 sets at least one of the first estimated remaining amount, the second estimated remaining amount, and the estimated usable amount to be displayed, which is received by selection based on an operation of the operation section 18. The setting section 127 causes the display section 17 to display, for example, a liquid amount display setting screen 130 illustrated in FIG. 9. A message MS1 prompting the user to select the liquid amount to be displayed at the replacement timing of the liquid accommodation body 30 is displayed on the liquid amount display setting screen 130. The liquid amount display setting screen 130 includes a selection option 131 for selecting the first estimated remaining amount, an selection option 132 for selecting the second estimated remaining amount, and an selection option 133 for selecting the estimated usable amount. The liquid amount display setting screen 130 includes an OK button 134 operated when the user sets the liquid amount, and a cancel button 135 operated when the user cancels the setting without setting the liquid amount. The user selects at least one of the three types of selection options 131 to 133 and then operates the OK button 134 to set the selection result of the liquid amount to be displayed at the replacement timing of the liquid accommodation body 30. In the liquid amount display setting screen 130 that is the example illustrated in FIG. 9, the selection options 131, 133 are in a selected state, and the selection option 132 is in a non-selected state. A user who wants to display all three types of liquid amount selection options selects all of selection options 131 to 133 and then selects the OK button 134. When the setting section 127 receives a selection result selected by the user operating the operation section 18 on the liquid amount display setting screen 130, the memory section 112 writes the received selection result in the setting storage region of the memory section 112 to set the selection result.

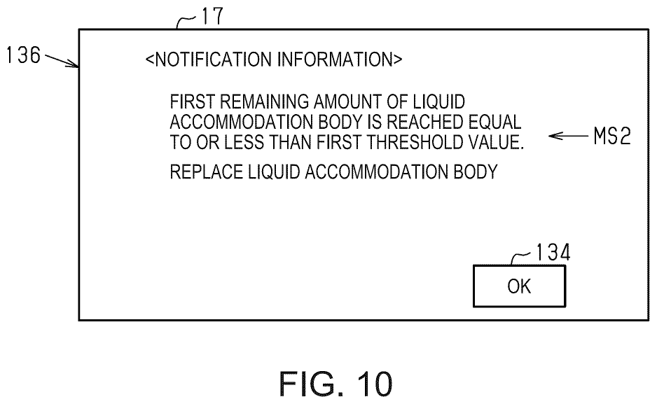

The notification processing section 128 performs processing for notifying information. The notification processing section 128 performs notification processing by causing the display section 17 having a notification function to display information. When the first remaining amount L1 becomes equal to or less than the first threshold value R1, the notification processing section 128 causes the display section 17 functioning as a notification section to notify information prompting replacement of the liquid accommodation body 30. The notification processing section 128 causes the display section 17 to display, for example, a notification screen 136 illustrated in FIG. 10. The notification screen 136 displays a message MS2 for notifying information indicating that the first remaining amount L1 of the liquid accommodation body 30 is equal to or less than the first threshold value R1 (for example, near-end state) and information prompting replacement of the liquid accommodation body 30. When the user confirms the notification information, the user operates the OK button 134.

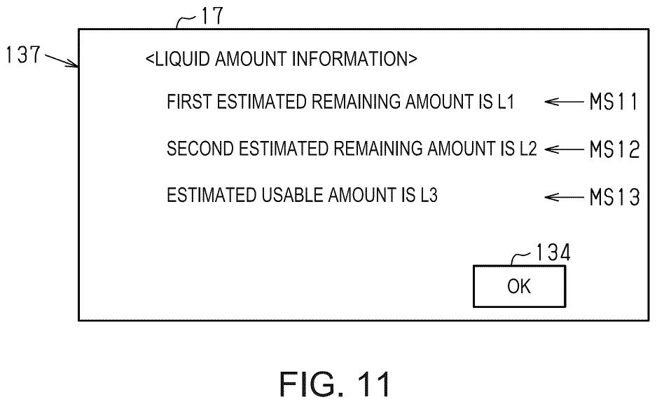

After executing the transfer mode, the notification processing section 128 causes the display section 17 to show information including at least one of the following: the first estimated remaining amount, the second estimated remaining amount, or the estimated usable amount, which is calculated by adding the first and second estimated remaining amounts. The notification processing section 128 causes the display section 17 to display, for example, a liquid amount information notification screen 137 illustrated in FIG. 11. The liquid amount information notification screen 137 illustrated in FIG. 11 displays a message MS11 for notifying the first estimated remaining amount L1, a message MS12 for notifying the second estimated remaining amount L2, and a message MS13 for notifying the estimated usable amount L3. The liquid amount information notification screen 137 displays the type and number of liquid amounts according to the selection content selected by the user on the liquid amount display setting screen 130 (FIG. 9) and received by the setting section 127. FIG. 11 shows a display example in which the user configures the display to show all three types of liquid amounts. When the user confirms the notified liquid amount, the user operates the OK button 134. The control section 100 may display the screens 130, 136 and 137 on the display section of the host device.

### Control Contents of Transfer Mode by Control Section 100

When the first remaining amount L1, which is the amount of liquid in the liquid accommodation body 30, becomes equal to or less than the first threshold value R1, the control section 100 executes the transfer mode in which the liquid in the liquid accommodation body 30 is transferred to the liquid storage section 40 until the second remaining amount L2, which is the amount of liquid in the liquid storage section 40, becomes equal to the second threshold value R2.

Furthermore, when the second remaining amount L2 becomes equal to or less than a third threshold amount R3 that is smaller than the second threshold value R2 after the execution of the transfer mode and before the replacement of the liquid accommodation body 30, the control section 100 executes the transfer mode again.

When the control section 100 detects that the first remaining amount L1 has reached the end state after the transfer mode is executed, the control section 100 does not execute the transfer mode again. That is, when it is detected that the first remaining amount L1 has reached the end state, the control section 100 sets the current transfer mode to the last transfer mode.

On the other hand, when the first remaining amount L1 is not detected to be end state after the transfer mode is executed, the control section 100 executes the transfer mode again.

The control section 100 outputs an error when the sensing section 43 detects that the second remaining amount L2 has reached the second threshold value R2, regardless of the execution of the transfer mode. On the other hand, the control section 100 does not output an error when the sensing section 43 detects that the second remaining amount L2 has reached the second threshold value R2 by the execution of the transfer mode. In other words, when the sensing section 43 detects that the second remaining amount L2 has reached the second threshold value R2 by the execution of the transfer mode, the detection is not an error because the detection is caused by the transfer of the liquid, and thus, an error is not output.

### Control Method of Liquid Ejection Device 11

The method for controlling the liquid ejection device 11 includes (A) and (B), which are described below.

(A) When the first remaining amount L1, which is the amount of liquid in the liquid accommodation body 30, becomes equal to or less than the first threshold value R1, the transfer mode is executed in which the liquid in the liquid accommodation body 30 is transferred to the liquid storage section 40 until the second remaining amount L2, which is the amount of liquid in the liquid storage section 40, becomes equal to the second threshold value R2.

(B) When the second remaining amount L2 of the liquid storage section 40 becomes equal to or less than the third threshold amount R3 after the transfer mode is executed and before the liquid accommodation body is replaced, the transfer mode is executed again.

Note that the above (A) corresponds to the processing of steps S11 and S14 to S19 in FIG. 12. The above (B) corresponds to the processing of steps S22, S14 to S19.

### Operations of First Embodiment

The operation of the liquid ejection device 11 according to the present embodiment will be described with reference to the flowchart illustrated of FIG. 12, as well as FIG. 2 and FIGS. 13 to 18. In FIGS. 2 and 13 to 18, the open state of the two flow path valves 48 and 49 is indicated by a white outline valve symbol, and the closed state thereof is indicated by a black painted valve symbol.

The user causes the display section 17 to display the liquid amount display setting screen 130 by an operation of selecting a setting item from the menu screen (home screen). In the liquid amount display setting screen 130, after at least one of the first estimated remaining amount, the second estimated remaining amount, and the estimated usable amount is selected, the OK button 134 is operated. The selection result of the liquid amount to be displayed, which is selected by the user on the liquid amount display setting screen 130, is received by the setting section 127. The setting section 127 sets the selection result by storing the selection result in a predetermined storage region of the memory section 112.

As shown in FIG. 2, during printing, the two flow path valves 48 and 49 are both opened, and the first storage chamber 71 and the second storage chamber 76 are opened to atmosphere. The liquid in the first storage chamber 71 and the second storage chamber 76 is supplied to the liquid ejection section 20 from both the supply flow path 46 and the recovery flow path 47 due to a water head difference.

When the liquid ejection device 11 is not printing, if the cleaning condition is satisfied, the liquid ejection section 20 is cleaned by the maintenance section 25. The cleaning is performed by forcibly discharging the liquid from the nozzle 21N toward the cap 26 by the ejection head 21 in a state where the nozzle opening area 21A of the ejection head 21 is capped by the cap 26. The liquid ejection device 11 is in a liquid circulation state or a standby state when the liquid ejection device 11 is neither in printing nor in cleaning. During the liquid circulation, the two flow path valves 48 and 49 are both opened, and the second storage chamber 76 is pressurized in a state where the first storage chamber 71 is opened to atmosphere. The liquid (for example, ink) is circulated along a circulation flow path 23. In the standby state, both of the two flow path valves 48 and 49 are in the closed state.

Hereinafter, the liquid transfer mode routine executed by the control section 100 will be described. The control section 100 may execute this routine in preference to the cleaning as long as the cleaning is not started. In addition, when a print job is received before the start of the execution of the transfer mode, printing based on the print job may be prioritized over the execution of the transfer mode. When the liquid ejection device 11 is in a turn-on state, the control section 100 executes the transfer mode routine at predetermined cycle time intervals. In the initialization operation when the power of the liquid ejection device 11 is turned on, the control section 100 sets the value of a counter (not illustrated) indicating the number of times N of execution of the transfer mode to “1” (N=1.)

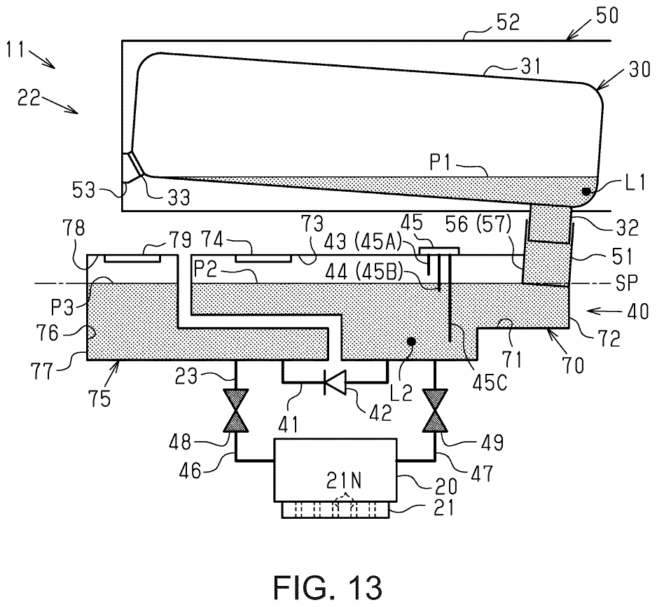

First, in step S11, the control section 100 determines whether or not the first remaining amount L1 of the liquid accommodation body is equal to or less than the first threshold value R1. The determination as to whether the first remaining amount L1 is equal to or less than the first threshold value R1 is performed based on the detection result of the detection section 90 and 123. It determines whether the first remaining amount L1 is equal to or less than the first threshold value R1 using at least one of the detection results of the detection section 90, which is a physical sensor such as an optical sensor, and the detection result of the detection section 123, which is a soft sensor. When the first threshold value R1 is, for example, the near-end state, the control section 100 determines whether the first remaining amount L1 is equal to or less than the near-end state. If the first remaining amount L1 is equal to or less than the first threshold value R1, the process proceeds to step S12, and if the first remaining amount L1 is not equal to or less than the first threshold value R1, the routine is terminated. For example, as shown in FIG. 13, when the first remaining amount L1 in the liquid accommodation body 30 becomes equal to or less than the first threshold value R1, the process proceeds to step S12.

In step S12, the control section 100 judges whether either printing or cleaning operations are in progress. If the printing or cleaning is not being performed, the control section 100 proceeds to step S13, and if the printing or cleaning is being performed, the control section 100 waits until the printing or cleaning is completed.

In step S13, the control section 100 determines whether the transfer mode is the first time (N=1.) If N=1, the process proceeds to step S14, and if N=1 is not satisfied, the process proceeds to step S22. In this case where the transfer mode is not executed even once, N=1, and thus the process proceeds to step S14.

In step S14, the control section 100 closes the circulation flow path 23. As illustrated in FIG. 13, the control section 100 closes the flow path valves 48 and 49 to close the supply flow path 46 and the recovery flow path 47. As a result, the communication between the liquid storage section 40 and the liquid ejection section 20 is blocked. When the liquid ejection device 11 is in the standby state, the flow path valves 48 and 49 is already in the closed state, and thus the closed state is maintained.

In the next step S15, the control section 100 opens the first storage chamber 71 to atmosphere. The control section 100 activates the first atmosphere opening section 63A of the transfer section 60 and opens both the atmosphere release valve 84 and the first on/off valve 86. As a result, the first storage chamber 71 is opened to atmosphere from the first atmosphere opening section 63A through the air flow path 88.

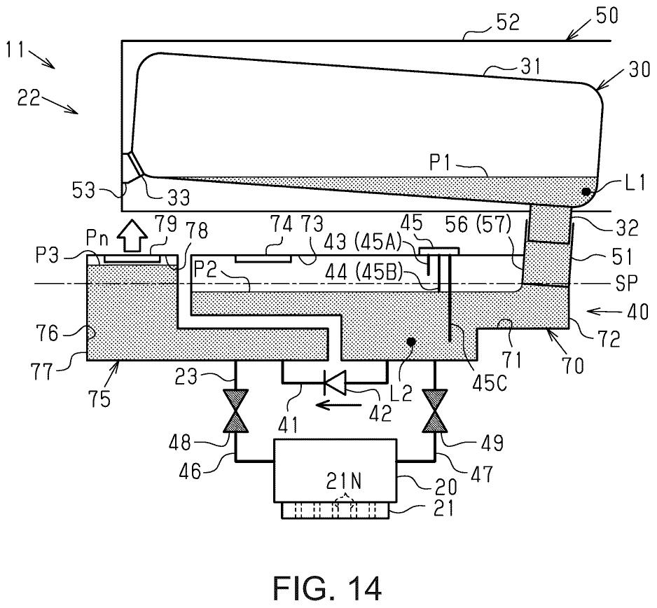

In the next step S16, the control section 100 depressurizes the second storage chamber 76 to the pressure Pn. The control section 100 activates the decompression section 61 of the transfer section 60 and opens both the on/off valve 82 and the second on/off valve 87. Accordingly, the second storage chamber 76 is depressurized to the pressure Pn by the negative pressure introduced from the decompression section 61 to the second storage chamber 76 through the air flow path 89. As a result, as shown in FIG. 14, the liquid level P3 in the second storage chamber 76 is pulled up by the negative pressure, and the liquid in the first storage chamber 71 moves to the second storage chamber 76 through the lead out flow path 41. The liquid level P2 in the first storage chamber 71 descends to a position lower than the reference liquid level SP. Accordingly, the gas-liquid exchange by the gas-liquid exchange section 57 constituting the liquid replenishment section 56 becomes possible. The control section 100 starts clocking the decompression time T1 in accordance with the start of depressurization.

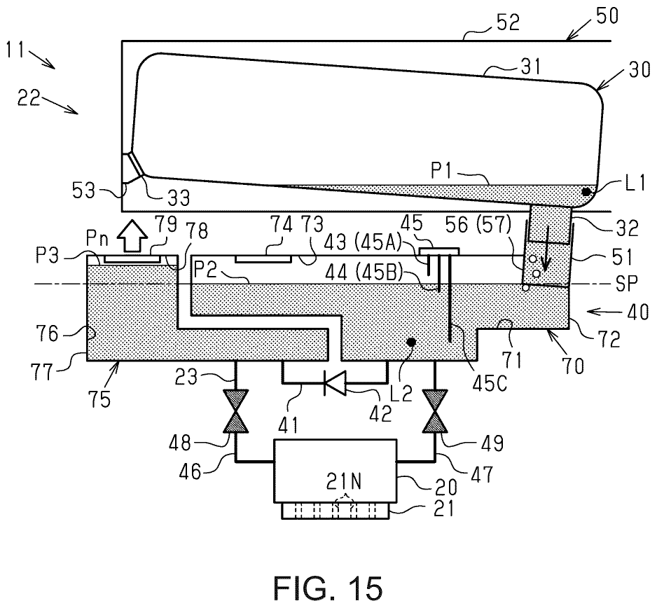

In the next step S17, the control section 100 determines whether or not the decompression time T1 has elapsed. The control section 100 waits as it is when the decompression time T1 has not elapsed, and proceeds to step S18 when the decompression time T1 has elapsed. As illustrated in FIG. 15, while the decompression time T1 elapses, the liquid is transferred from the liquid accommodation body 30 to the first storage chamber 71 by the liquid replenishment section 56 in the first storage chamber 71 with gas-liquid exchange.

In the next step S18, the control section 100 opens the second storage chamber 76 to atmosphere. In other words, the control section 100 controls the transfer section 60 to stop the driving of the decompression section 61 and opens both the atmosphere release valve 84 and the second on/off valve 87. As a result, the second storage chamber 76 is opened to atmosphere through the air flow path 89 by the second atmosphere opening section 63B.

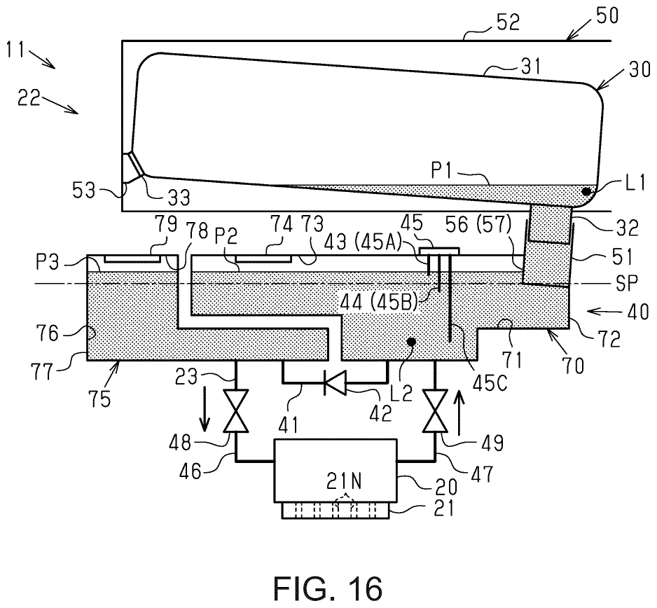

In the next step S19, the control section 100 opens the circulation flow path. As illustrated in FIG. 16, the control section 100 opens the flow path valves 48 and 49 to open the supply flow path 46 and the recovery flow path 47 constituting the circulation flow path 23. The first storage chamber 71 and the second storage chamber 76 communicate with each other through the circulation flow path 23. As a result, as shown in FIG. 15, the liquid in the second storage chamber 76 moves to the first storage chamber 71 through the circulation flow path 23 due to the water head difference between the liquid level P3 that has been rising in the second storage chamber 76 and the liquid level P2 at a height near the reference liquid level SP in the first storage chamber 71. Thus, the liquid level P2 in the first storage chamber 71 and the liquid level P3 in the second storage chamber 76 are at the same height. The liquid levels P2 and P3 immediately after the end of the transfer mode illustrated in FIG. 16 are higher than the liquid levels P2 and P3 before the start of the transfer mode illustrated in FIG. 13 by the amount of liquid transferred from the liquid accommodation body 30 to the first storage chamber 71. The amount of liquid transferred per transfer mode is set to an amount of liquid at which the liquid level P2 reaches the upper limit of the second remaining amount L2. Immediately after the end of the transfer mode, the first sensing section 43 detects that the first remaining amount L1 has reached the second threshold value R2. In other words, the first sensing section 43 detects that the liquid amount for one time of the transfer mode is transferred from the liquid accommodation body 30 to the first storage chamber 71.

In the next step S20, the control section 100 determines whether the second remaining amount L2 of the first storage chamber 71 has reached the second threshold value R2. That is, the control section 100 judges whether the sensing section 43 detected that the second remaining amount L2 reached the second threshold value R2. The control section 100 judges that the second remaining amount L2 has reached the second threshold value R2 when the sensing section 43 detects the liquid level P2 that reached to a height equal to or higher than the upper limit. When the control section 100 judges that the second remaining amount L2 reached the second threshold value R2, the control section 100 proceeds to step S21. On the other hand, when the control section 100 determines that the second remaining amount L2 has not reached the second threshold value R2, the control section 100 ends the present routine. In other word, it can be estimated that the liquid amount corresponding to one time of the transfer mode does not remain in the liquid accommodation body 30 immediately before the start of the transfer mode, and the liquid accommodation body 30 is in the end state by executing the transfer mode. Therefore, since it is not necessary to execute the transfer mode anymore, the present routine is ended.

In step S21, the control section 100 increments the number of times N of executing the transfer mode (N=N+1.) Thereafter, the control section 100 returns to the execution of step S11.

When one transfer mode is finished in this manner, the control section 100 decreases the first estimated remaining amount and increases the second estimated remaining amount by the estimated transfer amount of the liquid in the transfer mode. That is, the control section 100 updates the first estimated remaining amount and the second estimated remaining amount to the values immediately after the execution of the transfer mode. Further, the control section 100 calculates the estimated usable amount by adding the first estimated remaining amount and the second estimated remaining amount.

Further, the control section 100 reads the selection information of the user set by the setting section 127. The control section 100 causes the display section 17 to display at least one of the updated first estimated remaining amount, the updated second estimated remaining amount, and the updated estimated usable amount, which is selected based on the selection information. For example, the liquid amount information notification screen 137 illustrated in FIG. 11 is displayed on the display section 17. The user who views the liquid amount information notification screen 137 can acquire desired liquid amount information selected by the user from the first estimated remaining amount, the second estimated remaining amount, and the estimated usable amount.

When the first remaining amount L1 is equal to or less than the first threshold value R1 in the judgement of step S11, the control section 100 causes the display section 17 to display the notification screen 136 illustrated in FIG. 10. A message MS2 for notifying information prompting replacement of the liquid accommodation body 30 is displayed on the notification screen 136. When the user who saw the message MS2 replaces the liquid accommodation body 30, the first remaining amount L1 remaining in the replaced used liquid accommodation body 30 is reduced by at least the transport amount or more from the liquid amount at the time of the near-end state. On the other hand, there are also users who continue to use the liquid accommodation body 30 as it is even after the near-end state. As the liquid is consumed by the subsequent printing or cleaning, the liquid level P2 of the second remaining amount L2 in the first storage chamber 71 gradually lowers from the upper limit position. Then, the second remaining amount L2 in the first storage chamber 71 becomes equal to or less than the third threshold amount R3.

Since the first remaining amount L1 of the liquid accommodation body 30 is equal to or less than the first threshold value R1 in step S11, neither printing nor cleaning is being performed in step S12, and N=2 in step S13, the process proceeds to step S22.

In step S22, the control section 100 judges whether the second remaining amount L2 of the first storage chamber 71 is equal to or less than the third threshold amount R3. If the second remaining amount L2 is greater than the third threshold amount R3, each process in steps S11, S12 and S22 is repeatedly executed until the second remaining amount L2 becomes less than or equal to the third threshold amount R3 in step S22. Then, when the second remaining amount L2 becomes less than or equal to the third threshold amount R3 in step S22, the process proceeds to step S14.

In this way, the second transfer mode is executed by executing the processing of step S14 to step S19.

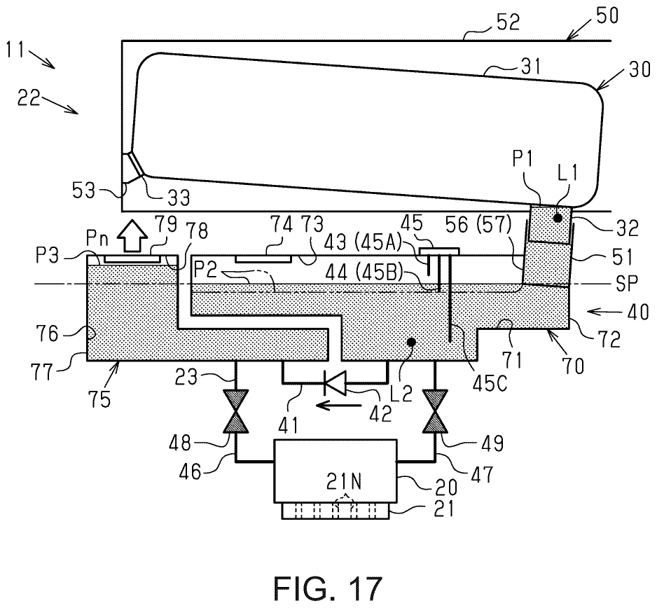

As illustrated in FIG. 17, the second storage chamber 76 is depressurized in a state where the two flow path valves 48 and 49 are closed and the first storage chamber 71 is open to atmosphere. As the liquid level P3 in the second storage chamber 76 rises, the liquid in the first storage chamber 71 moves to the second storage chamber 76 through the lead out flow path 41 and the one-way valve 42. As a result, the liquid level P2 in the second storage chamber 76 is lowered to a height indicated by a two-dot chain line in FIG. 17, which is lower than the reference liquid level SP. The liquid is transferred from the liquid accommodation body 30 to the first storage chamber 71 by the gas-liquid exchange performed by the liquid replenishment section 56.

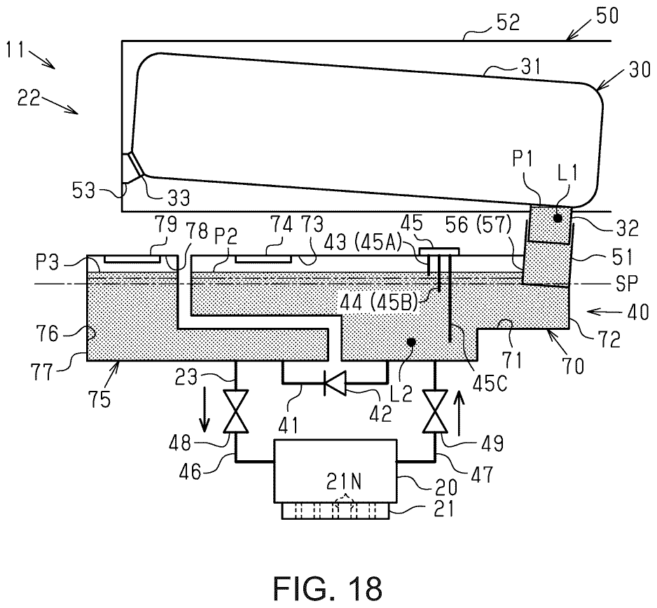

Thereafter, when the decompression time T1 elapses in step S17, the second storage chamber 76 is opened to atmosphere (step S18.) Further, the two flow path valves 48 and 49 are both opened at the step S19, and thereby the circulation flow path 23 is opened. As a result, the liquid in the second storage chamber 76 moves to the first storage chamber 71 through the circulation flow path 23 due to the water head difference between the liquid level P2 of the first storage chamber 71 and the liquid level P3 of the second storage chamber 76 illustrated in FIG. 17. As a result, as shown in FIG. 18, the liquid level P2 of the first storage chamber 71 and the liquid level P3 of the second storage chamber 76 are at the same height.

When the second remaining amount L2 of the first storage chamber 71 reaches the second threshold value R2 in step S20, the number of times N of executing the transfer mode is incremented in step S21. On the other hand, if the second remaining amount L2 does not reach the second threshold value R2 at the liquid level P2 indicated by the two-dot chain line in FIG. 18, it can be assumed that the liquid accommodation body 30 has reached its end state, and this routine is terminated.

In this way, the control section 100 repeats the consumption of the liquid and the execution of the transfer mode until the second remaining amount L2 does not reach the second threshold value R2 at step S20. The execution of the transfer mode is repeated until the liquid accommodation body 30 is finally at the end state. When the user replaces the liquid accommodation body 30, the frequency that the liquid accommodation body 30 to be replaced is the end state increases. Even if the liquid accommodation body 30 at the time of replacement is not at the end state, the first remaining amount L1 remaining in the liquid accommodation body 30 is frequently considerably smaller than the first remaining amount L1 at the time of the near-end state. Therefore, the liquid remaining in the replaced liquid accommodation body 30 is prevented from being wasted.

### Effects of First Embodiment

Effects according to the present embodiment will be described.

(1-1) When the first remaining amount L1, which is the amount of liquid in the liquid accommodation body 30, becomes equal to or less than the first threshold value R1, the control section 100 executes the transfer mode in which the liquid in the liquid accommodation body 30 is transferred to the liquid storage section 40 until the second remaining amount L2, which is the amount of liquid in the liquid storage section 40, becomes equal to the second threshold value R2. Furthermore, when the second remaining amount L2 becomes equal to or less than the third threshold amount R3, which is smaller than the second threshold value R2, after the transfer mode is executed and before the liquid accommodation body 30 is replaced, the control section 100 executes the transfer mode again. According to this configuration, when the second remaining amount L2 of the liquid storage section 40 becomes small after the transfer mode is executed, the transfer mode is executed again to transfer the liquid to the liquid storage section 40. The liquid that has not been completely transported in one transfer mode and remains in the liquid accommodation body 30 can be reduced by further transfer. The amount of liquid remaining in the liquid accommodation body 30 at the time of replacement can be further reduced. Therefore, by reducing the liquid remaining when the liquid accommodation body 30 is replaced, it is possible to suppress waste of the liquid.

(1-2) The liquid ejection device 11 includes the detection sections 90 and 123 that detect that the first remaining amount L1 of the liquid accommodation body 30 has reached the end state. When the control section 100 detects that the first remaining amount L1 has reached the end state after the transfer mode is executed, the control section 100 does not execute the transfer mode again. On the other hand, when the first remaining amount L1 is not detected to be end state after the transfer mode is executed, the control section 100 executes the transfer mode again. According to this configuration, when the first remaining amount L1 reaches the end state by the execution of the transfer mode, it is not necessary to execute the transfer mode again. Therefore, it is possible to avoid unnecessary execution of the transfer mode. For example, it is possible to avoid a delay in the replacement work of the liquid accommodation body 30, a delay in the start of printing, and the like due to the execution of the unnecessary transfer mode.

(1-3) The liquid ejection device 11 includes the sensing section 43 that physically detects that the second remaining amount L2 has reached the second threshold value R2. Therefore, the remaining amount can be reliably managed because the remaining amount is physically detected. For example, it is possible to confirm that the liquid is transferred without mistake in the transfer mode. In addition, for example, by confirming that a sufficient amount of liquid has not been transferred in the transfer mode, it can be estimated that the liquid accommodation body 30 has become empty or has certainly reached the end state.

(1-4) The sensing section 43 also serves as an error sensing section that detects, as an error, that the second remaining amount L2 has reached the second threshold value R2. The control section 100 outputs an error when the sensing section 43 detects that the second remaining amount L2 has reached the second threshold value R2, regardless of the execution of the transfer mode. On the other hand, the control section 100 does not output an error when the sensing section 43 detects that the second remaining amount L2 has reached the second threshold value R2 by the execution of the transfer mode. According to this configuration, since an error is not output when the second remaining amount becomes the second threshold value by the execution of the transfer mode, it is possible to suppress the confusion of the user due to the output of the error. When the sensing section 43 also serves as an overflow sensor, it is possible to suppress an error from being displayed due to the detection of an overflow.

(1-5) The first acquisition section 122 acquires the first remaining amount L1 of the liquid accommodation body 30 as the first estimated remaining amount. The second acquisition section 125 acquires the second remaining amount L2 of the liquid storage section 40 as the second estimated remaining amount. When the transfer mode is executed, the control section 100 decreases the first estimated remaining amount and increases the second estimated remaining amount by the estimated transfer amount of the liquid in the transfer mode. According to this configuration, it is possible to suppress the occurrence of a difference between the actual remaining amount and the estimated remaining amount. Therefore, the amount of the usable liquid can be appropriately managed.

(1-6) The control section 100 (the notification processing section 128) causes the display section 17 to display information including at least one of the first estimated remaining amount, the second estimated remaining amount, and the estimated usable amount obtained by adding the first estimated remaining amount and the second estimated remaining amount after the execution of the transfer mode. According to this configuration, the user can individually set the display setting, and thus the usability can be improved.

(1-7) The operation section 18 is operated when at least one of the selection option displayed on the display section 17 is selected. The setting section 127 receives and sets at least one of the first estimated remaining amount, the second estimated remaining amount, and the estimated usable amount to be displayed by selection based on an operation of the operation section 18. According to this configuration, the user can individually set the display setting, and thus the usability can be improved.

(1-8) When the first remaining amount L1 becomes equal to or less than the first threshold value R1, the control section 100 (the notification processing section 128) causes the display section 17 functioning as a notification section to notify information prompting replacement of the liquid accommodation body 30. According to this configuration, the user can know the replacement timing of the liquid accommodation body 30.

(1-9) The liquid ejection device 11 includes the liquid replenishment section 56 that replenishes the first storage chamber 71 with the liquid from the liquid accommodation body 30 via the mount section 50 when the liquid level P2 of the liquid storage section 40 becomes equal to or lower than the reference liquid level SP. Even if the liquid level P2 of the liquid storage section 40 is not equal to or lower than the reference liquid level SP, the transfer section 60 transfers the liquid by causing the liquid replenishment section 56 to replenish the liquid. According to this configuration, the liquid can be transferred using the liquid replenishment section 56.

(1-10) The liquid ejection device 11 includes the liquid replenishment section 56 that replenishes the first storage chamber 71 with the liquid from the liquid accommodation body 30 via the mount section 50 when the liquid level P2 of the liquid storage section 40 becomes equal to or lower than the reference liquid level SP. The transfer section 60 transfers the liquid from the liquid accommodation body 30 to the liquid storage section 40 via the mount section 50 by adjusting the air pressure in the liquid storage section 40 to lower the liquid level P2 to the reference liquid level SP or lower. According to this configuration, by setting the liquid level P2 in the liquid storage section 40 to be equal to or lower than the reference liquid level SP, the liquid can be transferred using the liquid replenishment section 56.

(1-11) The liquid storage section 40 includes the first storage chamber 71, the lead out flow path 41, the second storage chamber 76, the one-way valve 42, and the liquid replenishment section 56. The first storage chamber 71 stores liquid. The first storage chamber 71 stores the liquid supplied from the liquid accommodation body 30 via the mount section 50. The lead out flow path 41 has one end coupled to the first storage chamber 71 and allows the liquid in the first storage chamber 71 to flow out. The second storage chamber 76 is coupled to the other end of the lead out flow path 41 and stores the liquid supplied from the first storage chamber 71. The one-way valve 42 is provided in the lead out flow path 41. The one-way valve 42 regulates the direction in which the liquid flows through the lead out flow path to one direction from the first storage chamber 71 toward the second storage chamber 76. The liquid replenishment section 56 is provided to supply the liquid from the liquid accommodation body 30 to the first storage chamber 71 via the mount section 50 when the liquid level P2 of the liquid storage section 40 becomes equal to or lower than the reference liquid level SP. The decompression section 61 decompresses the second storage chamber 76. The first atmosphere opening section 63A is configured to open the inside of the first storage chamber 71 to atmosphere. The second atmosphere opening section 63B is configured to open the inside of the second storage chamber 76 to atmosphere. The control section 100 executes the transfer mode by opening the inside of the second storage chamber 76 to atmosphere after causing the transfer section 60 to reduce the pressure inside the second storage chamber 76 to make the liquid level P2 of the first storage chamber 71 equal to or lower than the reference liquid level SP. According to this configuration, even if the liquid replenishment section does not have a liquid transfer means such as a pump, the transfer mode can be executed by applying reduced pressure. This allows for a simplified flow path structure while suppressing waste caused by unused liquid remaining in the liquid accommodation body.

(1-12) The liquid ejection device 11 includes the supply flow path 46 that supplies the liquid from the liquid storage section 40 toward the liquid ejection section 20, and the recovery flow path 47 that recovers the liquid from the liquid ejection section 20 to the liquid storage section 40. According to this configuration, while suppressing the thickening of the liquid and collecting foreign matters such as bubbles in liquid through liquid circulation, the long flow path required for liquid circulation allows the device side to retain a larger amount of liquid.

(1-13) A control method of the liquid ejection device 11 including the liquid ejection section 20, the liquid storage section 40, the mount section 50, and the transfer section 60 includes the following (A) and (B).

(A) When the first remaining amount L1, which is the amount of liquid in the liquid accommodation body 30, becomes equal to or less than the first threshold value R1, the transfer mode is executed in which the liquid in the liquid accommodation body 30 is transferred to the liquid storage section 40 until the second remaining amount L2, which is the amount of liquid in the liquid storage section 40, becomes equal to the second threshold value R2.

(B) After the transfer mode was executed and before the liquid accommodation body 30 is replaced, if the second remaining amount L2, which is the amount of liquid in the liquid storage section 40, becomes less than or equal to the third threshold amount R3, which is smaller than the second threshold value R2, the transfer mode is executed again.

According to this method, the frequency of reducing the amount of liquid remaining in the liquid accommodation body 30 until the user replaces the liquid accommodation body 30 is increased by repeatedly performing the transfer mode. Therefore, it is possible to suppress waste in which the liquid remaining in the liquid accommodation body is not used.

### Second Embodiment

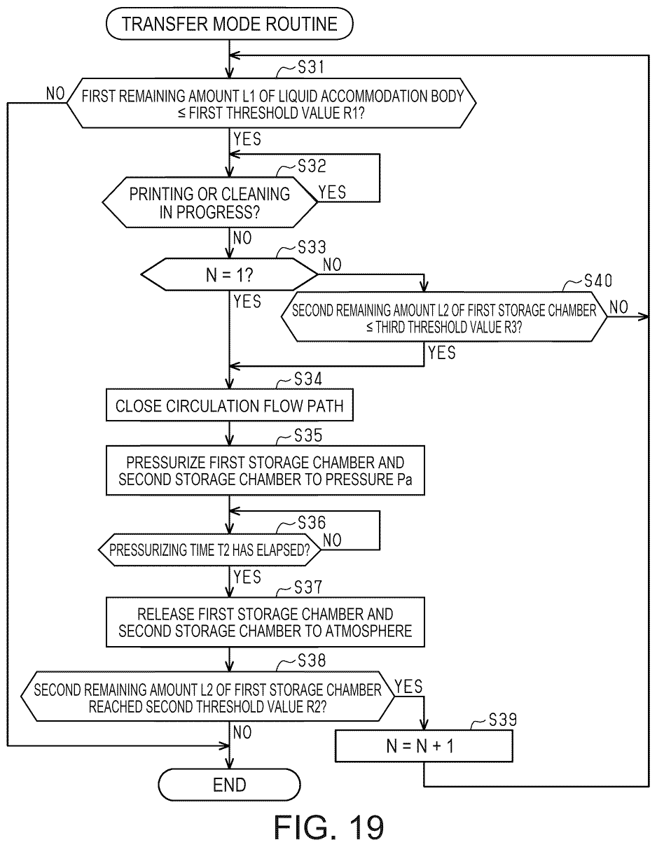

Next, a second embodiment will be described with reference to FIGS. 19 to 22. The configuration of the liquid ejection device 11 is the same as that of the first embodiment. Therefore, the same reference numerals are given to the same members as those of the first embodiment, and the description thereof will be omitted. The second embodiment is different from the first embodiment in the content of the transfer mode. Hereinafter, the contents of the transfer mode executed by the control section 100 will be mainly described.

The liquid ejection device 11 includes the liquid supply unit 22 similar to that of the first embodiment. The configuration of the liquid supply unit 22 is the same as that of the first embodiment. The liquid ejection device 11 includes the liquid storage section 40, the mount section 50, the transfer section 60, and the control section 100. The liquid accommodation body 30 is mounted on the mount section 50. The liquid in the liquid accommodation body 30 is supplied to the liquid storage section 40 via the mount section 50. The liquid storage section 40 includes the first storage chamber 71, the lead out flow path 41, the second storage chamber 76, the one-way valve 42, and the liquid replenishment section 56.

The first storage chamber 71 stores the liquid supplied from the liquid accommodation body 30 via the mount section 50. The lead out flow path 41 has one end coupled to the first storage chamber 71 and allows the liquid in the first storage chamber 71 to flow out. The second storage chamber 76 is coupled to the other end of the lead out flow path 41 and stores the liquid supplied from the first storage chamber 71. The one-way valve 42 regulates the direction in which the liquid flows through the lead out flow path 41 to one direction from the first storage chamber 71 toward the second storage chamber 76.

When the liquid level P2 of the first storage chamber 71 becomes equal to or lower than the reference liquid level SP, the liquid replenishment section 56 replenishes the first storage chamber 71 with the liquid from the liquid accommodation body 30 via the mount section 50. The liquid replenishment section 56 is, for example, the gas-liquid exchange section 57, and when the liquid level P2 of the second remaining amount L2 becomes equal to or lower than the reference liquid level SP, the liquid is replenished from the liquid accommodation body 30 to the first storage chamber 71 by gas-liquid exchange.

The transfer section 60 includes the pressurizing section 62, the first atmosphere opening section 63A, and the second atmosphere opening section 63B. The pressurizing section 62 pressurizes at least the first storage chamber 71 among the first storage chamber 71 and the second storage chamber 76. The first atmosphere opening section 63A is configured to open the inside of the first storage chamber 71 to atmosphere. The second atmosphere opening section 63B is configured to open the inside of the second storage chamber 76 to atmosphere.

In the first embodiment, the transfer mode is executed using the decompression section 61, but in the second embodiment, the transfer mode is executed using the pressurizing section 62. The control section 100 executes the transfer mode by causing the transfer section 60 to pressurize at least the inside of the first storage chamber 71 to make the liquid level P2 of the first storage chamber 71 equal to or lower than the reference liquid level SP and then opening at least the pressurized first storage chamber 71 to atmosphere. The pressurizing section 62 of the present embodiment is configured to individually pressurize the first storage chamber 71 and the second storage chamber 76. In the transfer mode, the control section 100 pressurizes both the first storage chamber 71 and the second storage chamber 76.

### Operations of Second Embodiment

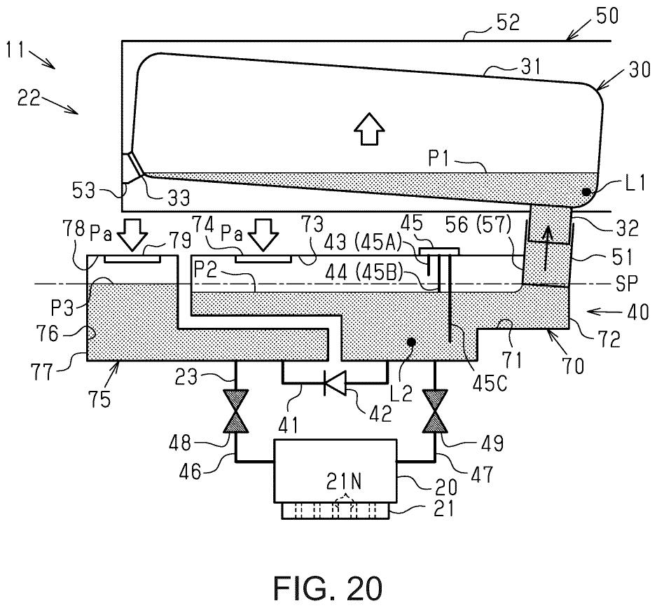

Next, the operation of the liquid ejection device 11 according to the second embodiment will be described with reference to the flowchart illustrated in FIG. 18, as well as FIG. 2, and FIGS. 20 to 22. In FIGS. 2 and 13 to 18, the open state of the two flow path valves 48 and 49 is indicated by a white outline valve symbol, and the closed state thereof is indicated by a black painted valve symbol.

First, the processes of step S31 to step S34 are the same as the processes of step S11 to step S14 in the first embodiment.

In a case where the first remaining amount L1 of the liquid accommodation body 30 is equal to or less than the first threshold value R1 in step S31 and neither printing nor cleaning is being performed in step S32, the current timing is the first transfer mode (N=1) in step S33, and thus the process proceeds to step S34.

The control section 100 executes the first transfer mode by executing the processes of step S34 to step S37. That is, the control section 100 closes the circulation flow path 23 at step S34. That is, the control section 100 closes both of the two flow path valves 48 and 49.

In the next step S35, the control section 100 pressurizes the first storage chamber 71 and the second storage chamber 76 using pressure Pa. The control section 100 activates the pressurizing section 62 of the transfer section 60 and opens all of the on/off valve 83, the first on/off valve 86, and the second on/off valve 87. Accordingly, the first storage chamber 71 and the second storage chamber 76 are pressurized to the pressure Pa by the positive pressure introduced from the pressurizing section 62 to the first storage chamber 71 and the second storage chamber 76 through the air flow paths 88 and 89. As a result, as shown in FIG. 20, the liquid surface P2 in the first storage chamber 71 and the liquid surface P3 in the second storage chamber 76 are pressed by the pressurization. The pressurization of the second storage chamber 76 prevents the liquid in the first storage chamber 71 from moving to the second storage chamber 76 through the lead out flow path 41 and the one-way valve 42. In a state where the movement of the liquid to the second storage chamber 76 is suppressed, the liquid in the first storage chamber 71 moves to the liquid accommodation body 30 through the replenishment flow path 58 and the mount section 50. At this time, the air inside the liquid accommodation body 30 is compressed by being pressurized.

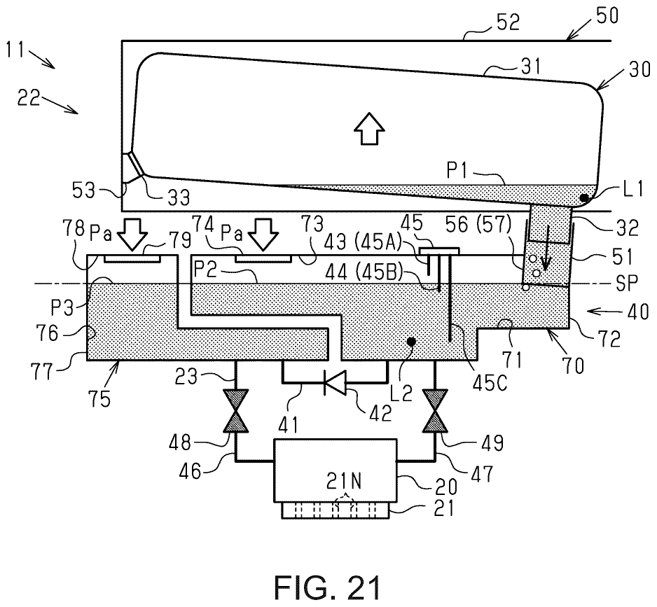

As a result of the movement of the liquid to the liquid accommodation body 30, the pressurized liquid surface P2 in the first storage chamber 71 is lowered to a position lower than the reference liquid level SP. This enables gas-liquid exchange by the gas-liquid exchange section 57 constituting the liquid replenishment section 56. Then, as shown in FIG. 21, the liquid in the liquid accommodation body 30 is transferred to the first storage chamber 71 by the gas-liquid exchange by the gas-liquid exchange section 57. The control section 100 starts measuring the pressurizing time T2 in accordance with the start of pressurizing.

In the next step S36, the control section 100 judges whether or not the pressurizing time T2 has elapsed. The control section 100 waits as it is when the pressurizing time T2 has not elapsed, and proceeds to step S37 when the pressurizing time T2 has elapsed. As illustrated in FIG. 21, while the pressurizing time T2 elapses, the liquid is transferred from the liquid accommodation body 30 to the first storage chamber 71 by the liquid replenishment section 56 in the first storage chamber 71 with gas-liquid exchange.

In the next step S37, the control section 100 opens the first storage chamber 71 and the second storage chamber 76 to atmosphere. That is, the control section 100 controls the transfer section 60 to stop the driving of the pressurizing section 62 and opens all of the atmosphere release valve 84, the first on/off valve 86, and the second on/off valve 87. Accordingly, the first storage chamber 71 is opened to atmosphere through the air flow path 88 by the first atmosphere opening section 63A, and the second storage chamber 76 is opened to atmosphere through the air flow path 89 by the second atmosphere opening section 63B.

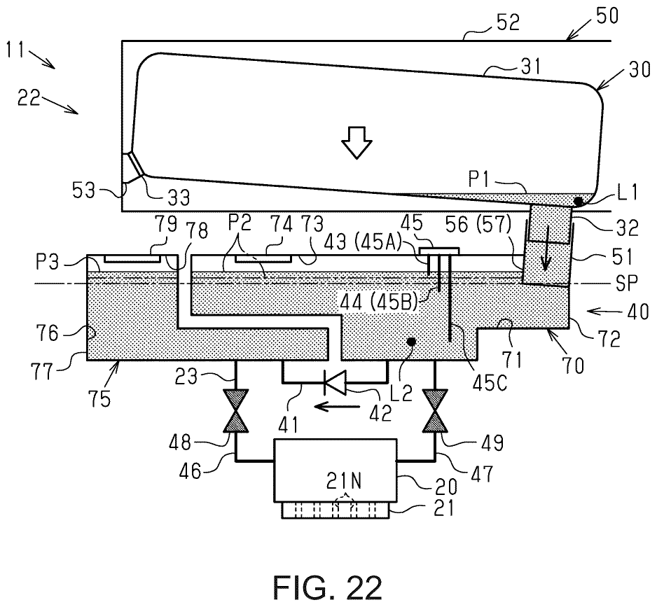

As shown in FIG. 22, when both the first storage chamber 71 and the second storage chamber 76 are opened to atmosphere, the liquid level P2 in the first storage chamber 71 and the liquid level P3 in the second storage chamber 76 are raised. The liquid levels P2 and P3 immediately after the end of the transfer mode illustrated in FIG. 22 are higher than the liquid levels P2 and P3 (for example, the vicinity of the reference liquid level SP) before the start of the transfer mode by the amount of liquid transferred from the liquid accommodation body 30 to the first storage chamber 71. The amount of liquid transferred per transfer mode is set to an amount of liquid at which the liquid level P2 reaches the upper limit of the second remaining amount L2.

In the next step S38, the control section 100 judges whether the second remaining amount L2 of the first storage chamber 71 has reached the second threshold value R2. That is, the control section 100 judges whether the sensing section 43 detected that the second remaining amount L2 reached the second threshold value R2. When the sensing section 43 detects the liquid level P2 that has risen to a height equal to or higher than the upper limit, the control section 100 judges that the second remaining amount L2 has reached the second threshold value R2. When the control section 100 judges that the second remaining amount L2 has reached the second threshold value R2, the control section 100 proceeds to step S39. On the other hand, when the control section 100 determines that the second remaining amount L2 has not reached the second threshold value R2, the control section 100 ends the present routine. In other word, it can be estimated that the liquid amount corresponding to one time of the transfer mode does not remain in the liquid accommodation body 30 immediately before the start of the transfer mode, and the liquid accommodation body 30 is in the end state by executing the transfer mode. Therefore, since it is not necessary to execute the transfer mode anymore, the present routine is ended.

In step S39, the control section 100 increments the number of times N of executing the transfer mode (N=N+1). Thereafter, the control section 100 returns to step S31.

Since the first remaining amount L1 of the liquid accommodation body 30 is equal to or less than the first threshold value R1 in step S31, neither printing nor cleaning is being performed in step S32, and N=2 in step S33, the process proceeds to step S40.

In step S40, the control section 100 judges whether the second remaining amount L2 of the first storage chamber 71 is equal to or less than the third threshold amount R3. If the second remaining amount L2 is not equal to or less than the third threshold amount R3, the processes of step S31 to step S33 and step S40 are repeatedly executed until it is judged in step S40 that the second remaining amount L2 is equal to or less than the third threshold amount R3. Then, when the second remaining amount L2 becomes equal to or less than the third threshold amount R3 in step S40, the process proceeds to step S34.

In this way, the control section 100 executes the second transfer mode by executing the processing of step S34 to step S37. By executing the transfer mode by pressurization illustrated in FIGS. 20 to 23, the liquid for one time of the transfer mode is transferred from the liquid accommodation body 30 to the first storage chamber 71.

In this way, the control section 100 repeats the consumption of the liquid and the execution of the transfer mode until the second remaining amount L2 does not reach the second threshold value R2 at step S38. When the user replaces the liquid accommodation body 30, the frequency that the liquid accommodation body 30 to be replaced is the end state increases. Even if the liquid accommodation body 30 is not at the end state of its usage at the time of replacement, the first remaining amount L1 in the liquid accommodation body 30 is often significantly smaller than the first remaining amount L1 at the near-end state. Therefore, the liquid remaining in the replaced liquid accommodation body 30 is prevented from being wasted.

A method of controlling the liquid ejection device 11 according to the second embodiment is the same as the method of controlling the liquid ejection device 11 according to the first embodiment. The (A) in the control method of the liquid ejection device 11 corresponds to the processing of steps S31 as well as step S34 to step S37 in FIG. 19. The above (B) corresponds to the processing of steps S40 as well as step S34 to step S37.

### Effects of Second Embodiment

According to the second embodiment, the effects (1-1) to (1-13) of the first embodiment can be similarly obtained, and the following effects can be obtained.

(2-1) The liquid storage section 40 includes the first storage chamber 71, the lead out flow path 41, the second storage chamber 76, the one-way valve 42, and the liquid replenishment section 56. The transfer section 60 includes the pressurizing section 62, the first atmosphere opening section 63A, and the second atmosphere opening section 63B. The control section 100 executes the transfer mode by causing the transfer section 60 to pressurize at least the inside of the first storage chamber 71 to make the liquid level P2 of the first storage chamber 71 equal to or lower than the reference liquid level SP and then opening at least the pressurized first storage chamber 71 to atmosphere. According to this configuration, even in a configuration in which the liquid replenishment section 56 does not include a liquid transfer means such as a pump, the transfer mode can be executed by pressurizing the first storage chamber 71. Therefore, it is possible to suppress waste in which the liquid remaining in the liquid accommodation body 30 is not used while simplifying the flow path configuration.

### Third Embodiment

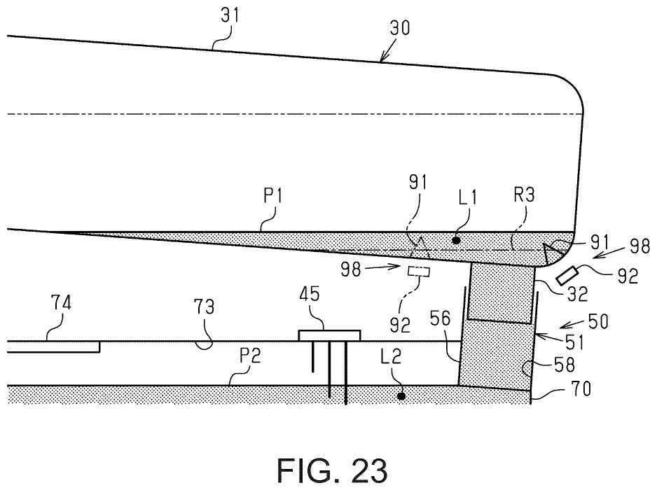

Next, a third embodiment will be described with reference to FIG. 23. In each of the embodiments described above, the fact that the liquid accommodation body 30 has reached the end state is estimated based on the detection result of the sensing section 43 after the execution of the transfer mode. In contrast, in the present embodiment, the liquid ejection device 11 includes a second detection section 98 that physically detects that the first remaining amount L1 of the liquid accommodation body 30 has reached the end state. As shown in FIG. 23, the second detection section 98 is configured by the prism 91 provided at a position corresponding to the liquid level height corresponding to the end state (for example, the ink end state) of the liquid accommodation body 30, and the optical sensor 92 disposed at a position facing the prism 91. The configurations of the prism 91 and the optical sensor 92 are the same as those of the detection section 90 in the first embodiment, and are different in that the liquid level height to be detected is the end threshold value RE instead of the first threshold value R1. Therefore, the optical sensor 92 includes the light emitting section 96 and the light receiving section 97 (see FIG. 6 for both).

The second detection section 98 may be disposed at the bottom section of the main body 31 as indicated by the two-dot chain line in FIG. 23 as long as the second detection section 98 can detect that the first remaining amount L1 is equal to or less than the end threshold value RE. The second detection section 98 may be disposed on a side section, a bottom section, or a corner section between the bottom section and the side section of the main body 31. Further, the second detection section 98 may be provided in the supply section 32, not limited to the main body 31. That is, the liquid level of the end threshold value RE may be in the supply section 32.

Before the first remaining amount L1 in the liquid accommodation body 30 reaches the end threshold value RE, the light from the light emitting section 96 passes through the prism 91, and thus the light reception detection value of the optical sensor 92 is equal to or less than the detection threshold value. Therefore, the second detection section 98 does not detect the end state. When the first remaining amount L1 in the liquid accommodation body 30 becomes equal to or less than the end threshold value RE, the light emitted by the light emitting section 96 is reflected by the prism 91, and thus the light reception detection value of the optical sensor 92 exceeds the detection threshold value. Accordingly, the second detection section 98 detects that the first remaining amount L1 of the liquid accommodation body 30 has reached the end state.

The control section 100 judges whether or not the first remaining amount L1 in the liquid accommodation body 30 has reached the end state in step S20 or step S38 in the transfer mode routine shown in FIG. 12 or FIG. 19. If the first remaining amount L1 has not reached the end state, the process proceeds to step S21 or step S39, and if the first remaining amount L1 has reached the end state, the routine is ended. In this manner, in step S20 or step S38, the judgement of whether or not the first remaining amount L1 in the liquid accommodation body 30 has reached the end state may be performed based on the detection result of the second detection section 98. According to this embodiment, since the second detection section including the physical sensor detects that the liquid accommodation body 30 has reached the end state, the liquid can be more reliably transferred until the liquid accommodation body 30 reaches the end state, compared to a configuration in which the end state is estimated by a soft sensor.

### Modifications

The present embodiment can be implemented with the following modifications. The present embodiment and the following modifications can be implemented in combination with each other as long as there is no technical contradiction.

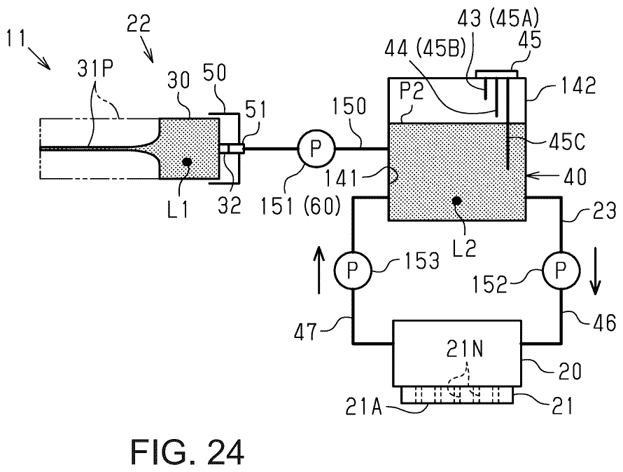

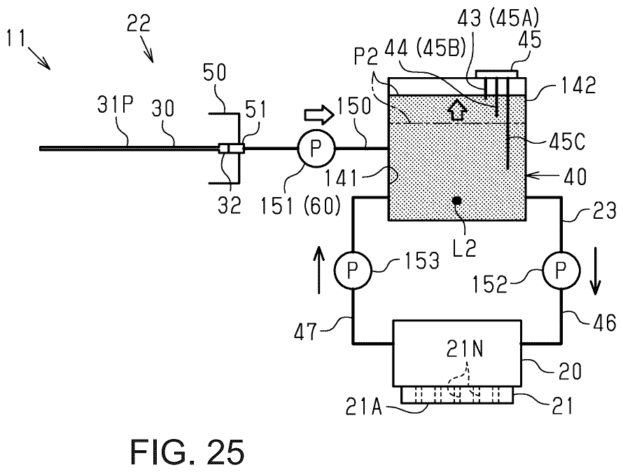

As illustrated in FIGS. 24 and 25, the liquid storage section 40 may have only one storage chamber. The liquid replenishment section is not limited to the gas-liquid exchange section 57, and may be a pump 151 that functions as a transfer means. For example, the pump 151 is provided in a replenishment flow path 150 that connects the mount section 50 and the liquid storage section 40. The liquid accommodation body 30 is not limited to a liquid cartridge (for example, an ink cartridge) in which a liquid such as ink is contained, and may be a liquid pack 31P (for example, an ink pack) in which a liquid such as ink is contained in a pack. The liquid storage section 40 includes a storage chamber 141 that stores liquid. The storage chamber 141 is formed inside a housing 142. The liquid ejection device 11 may include the electrode type sensor 45 that detects the second remaining amount L2 in the storage chamber 141. The electrode type sensor 45 may include the first sensing section 43 and the second sensing section 44. For example, when the second sensing section 44 detects that the second remaining amount L2 is less than the lower limit, the pump 151 functioning as the liquid replenishment section is driven, and thus the liquid may be replenished from the liquid accommodation body 30 to the liquid storage section 40 via the mount section 50. The circulation flow path 23 may be formed by connecting the liquid storage section 40 having only one storage chamber 141 and the liquid ejection section 20 through the supply flow path 46 and the recovery flow path 47. That is, the supply flow path 46 that supplies the liquid from the liquid storage section 40 toward the liquid ejection section 20 and the recovery flow path 47 that recovers the liquid from the liquid ejection section 20 to the liquid storage section 40 may be provided. Pumps 152 and 153 may be provided in the supply flow path 46 and the recovery flow path 47, respectively. The pump 152 provided in the supply flow path 46 is a feed pump, and the pump 153 provided in the recovery flow path 47 is a recovery pump.

The control section 100 executes a transfer mode in which the liquid in the liquid accommodation body 30 is transferred to the liquid storage section 40 until the second remaining amount L2, which is the amount of liquid in the liquid storage section 40, reaches the second threshold value R2 shown in FIG. 25, when the first remaining amount L1, which is the amount of liquid in the liquid accommodation body 30, falls below the first threshold value R1 shown in FIG. 24. As illustrated in FIG. 25, in the transfer mode, the control section 100 transfers the liquid by driving the pump 151. That is, the pump 151 functions as the transfer section 60. The pump 151 functioning as the liquid replenishment section is used as the transfer section. For example, when the first sensing section 43 detects that the second remaining amount L2 has reached the second threshold value R2, the control section 100 stops the driving of the pump 151. Furthermore, when the second remaining amount L2 becomes equal to or less than a third threshold amount R3 that is smaller than the second threshold value R2 after the execution of the transfer mode and before the replacement of the liquid accommodation body 30, the control section 100 executes the transfer mode again. The second sensing section 44 detects that the second remaining amount L2 is equal to or less than the third threshold amount R3. The third threshold amount R3 may be, for example, a lower limit amount (lower limit value) of the second remaining amount L2 detected by the second sensing section 44, or may be a value other than the lower limit. The second sensing section that detects that the second remaining amount L2 is equal to or less than the third threshold amount R3 may be a soft sensor, and may be configured to execute the transfer mode again when the second remaining amount estimation value, which is an estimation value of the second remaining amount L2, is equal to or less than the third threshold amount R3.

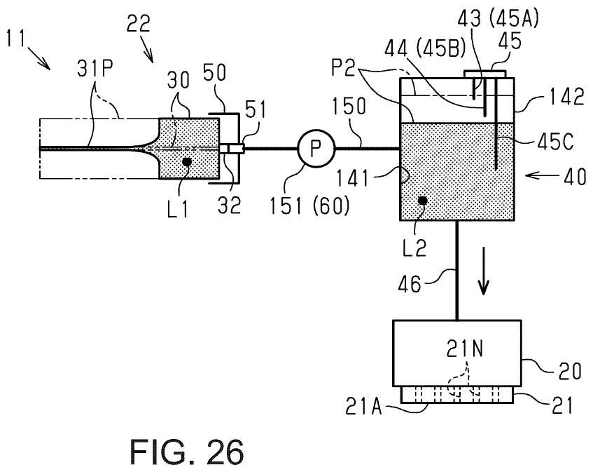

The liquid ejection device 11 may have a configuration in which the circulation flow path 23 formed by the supply flow path 46 and the recovery flow path 47 is not provided. For example, as illustrated in FIG. 26, the liquid storage section 40 and the liquid ejection section 20 may be coupled with each other only by one supply flow path 46. The supply of the liquid from the liquid storage section 40 to the liquid ejection section 20 through the supply flow path 46 may be performed by a water head difference between the liquid storage section 40 and the liquid ejection section 20. By driving the pump 151, replenishment of the liquid from the liquid accommodation body 30 to the liquid storage section 40 and transfer of the liquid from the liquid accommodation body 30 to the liquid storage section 40 in the transfer mode are performed. That is, the pump 151 functions as a liquid replenishment section and the transfer section 60. In the transfer mode, when the first sensing section 43 detects that the liquid level P2 has reached the second threshold value R2 indicated by the two-dot chain line in FIG. 26 due to the transfer of the liquid, the driving of the pump 151 is stopped. When the second sensing section 44 detects that the second remaining amount L2 is equal to or less than the third threshold amount R3, the control section 100 executes the transfer mode again.

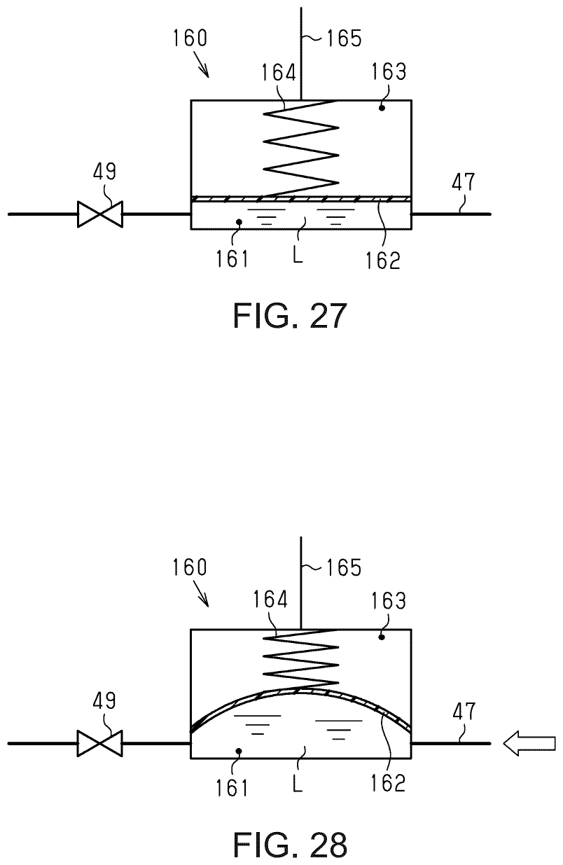

The portion in which the liquid transferred in the transfer mode is stored may be a flow path. For example, a liquid storage section may be provided as a buffer capable of storing liquid in the flow path. For example, a variable capacity liquid storage section 160 that functions as a buffer illustrated in FIGS. 27 and 28 may be provided in the recovery flow path 47. Although the liquid storage section 160 is provided in the recovery flow path 47 in the example illustrated in FIG. 5, the flow path may be another flow path such as the supply flow path 46 or the replenishment flow path 150. A plurality of liquid storage sections 160 may be provided in one flow path, or they may be provided over a plurality of flow paths. As illustrated in FIG. 27, the variable capacity liquid storage section 160 includes a liquid chamber 161 which is a part of the recovery flow path 47, a flexible section 162, an air chamber 163 separated from the liquid chamber 161 via the flexible section 162, and a spring 164 provided in the air chamber 163. An air flow path 165 communicates with the air chamber 163. The spring 164 is biased in a direction in which the flexible section 162 is pushed. That is, the spring 164 is biased in a direction in which the volume of the liquid chamber 161 is reduced. The air chamber 163 is coupled with the selector valve 80 of the transfer section 60 shown in FIG. 2 through the air flow path 165. The selector valve 80 has an on/off valve (not shown) that can open and close the air flow path 165. In a state where the on/off valve is opened, the transfer section 60 can switch between introduction of the negative pressure generated by the decompression section 61 into the air chamber 163 and introduction of the positive pressure generated by the pressurizing section 62 into the air chamber 163. The control section 100 can switch the pressure introduced into the air chamber 163 through the air flow path 165 between depressurization and pressurization by controlling the transfer section 60.

The variable capacity liquid storage section 160 changes the volume of the liquid chamber 161 separated from the air chamber 163 via the flexible section 162 by depressurizing or pressurizing the air chamber 163 through the air flow path 165. That is, the variable liquid storage section 160 changes the volume of the liquid chamber 161 by pneumatic driving by the transfer section 60. Before the transfer mode is started, the liquid storage section 160 is in an initial state in which the volume of the liquid chamber 161 illustrated in FIG. 27 is small. As illustrated in FIG. 28, in the transfer mode, the control section 100 reduces the pressure of the air chamber 163 through the air flow path 165 in a state where the flow path valve 49 is closed, thereby causing the flexible section 162 to be bent and deformed in a direction in which the volume of the liquid chamber 161 increases. The liquid drawn from the liquid storage section 40 side is stored in the liquid chamber 161 by the expansion of the volume of the liquid chamber 161. By storing the liquid in the liquid storage section 160 of a variable capacity type provided in the recovery flow path 47 in addition to the liquid storage section 40, it is possible to increase the amount of liquid transferred per transfer mode. Therefore, even if the liquid remains when the liquid accommodation body 30 is replaced, the amount of the remaining liquid is easily reduced. It is possible to further suppress waste of the liquid in which the liquid accommodation body 30 is replaced while the liquid remains. The liquid stored in the liquid chamber 161 may be retained until the liquid accommodation body 30 reaches its end state, becomes empty, or is replaced. Alternatively, it may be returned to the liquid storage section 40 when the liquid level P2 drops due to liquid consumption, or it may be supplied to the liquid ejection section 20 and used for cleaning or other purposes.

In the first embodiment, during the transfer mode, the second storage chamber 76 is depressurized and the first storage chamber 71 is opened to atmosphere; however, the second storage chamber 76 may be depressurized and the first storage chamber 71 may instead be pressurized. In this way, in a configuration in which the transfer mode is executed using the replenishment of the liquid by the liquid replenishment section 56, the mode of the pressure adjustment for lowering the liquid level P2 of the second remaining amount L2 below the reference liquid level SP can be selected as appropriate. In this case, when the pressure holding time has elapsed at the adjusted pressure, both of the two storage chambers 71 and 76 are opened to atmosphere, and the flow path valves 48 and 49 is opened.

In the second embodiment, the pressurizing section 62 may pressurize at least the first storage chamber 71 of the first and second storage chambers 71 and 76. For example, the first storage chamber 71 may be pressurized, and the second storage chamber 76 may not be pressurized. In this case, when the first storage chamber 71 is pressurized, the second storage chamber 76 may be blocked from atmosphere by closing the second on/off valve 87. If there is little risk of the liquid level P3 overflowing without pressurizing the second storage chamber 76, and there are no issues with liquid transfer, pressurization of the second storage chamber 76 is not necessary.

A configuration may be adopted in which an on/off valve is provided in the lead out flow path 41 and the second storage chamber 76 is not pressurized by closing the on/off valve. As described above, the pressurization may be performed on at least the first storage chamber 71 of the first and second storage chambers 71 and 76.

The first threshold value R1 is not limited to the threshold value for the near-end state, and may be a threshold value dedicated to the transfer mode, which is different from the threshold value for the near-end state. The first threshold value R1 may be greater than the threshold value of the near-end state. In this case, since the transfer mode is executed earlier than the replacement timing of the liquid accommodation body 30, it is possible to increase the frequency at which the amount of liquid remaining in the liquid accommodation body 30 at the timing of replacement is further reduced.

The second threshold value R2 is not limited to the upper limit amount (upper limit value) that can be stored in the liquid storage section 40, and may be a threshold value dedicated to the transfer mode.

The third threshold value is not limited to the same value as the second threshold value (for example, the upper limit amount), and may be a threshold value that is even smaller than the second threshold value (for example, the upper limit amount).

The sensing section that detects the second remaining amount L2 is not limited to the first sensing section 43 and the second sensing section 44 that are physical sensors, and may be a first sensing section and a second sensing section that are soft sensors.

The transfer mode may be executed immediately after it is detected that the first remaining amount L1 is equal to or less than the first threshold value R1 (for example, the near-end state). If the first remaining amount L1 is detected to have fallen below the first threshold value (a positive judgement in Step S11 or Step S31), and a print job has already been accepted, priority may be given to printing based on the print job.

The sensing section is not limited to being shared with the first sensing section 43 that detects the upper limit of the liquid amount (for example, the overflow threshold value), and may be a sensing section dedicated to the transfer mode. The second threshold value R2 is not limited to the overflow threshold value, and can be set to a value suitable for the transfer mode. For example, if the second threshold value R2 detected by the sensing section is set to be smaller than the upper limit value, overflow during the transfer mode can be easily avoided. For example, this is effective when the upper limit value has a small margin.

Instead of the sensing section 43 including the physical sensor illustrated in FIGS. 24 to 26, the sensing section 126 including a soft sensor may detect that the second remaining amount L2 has reached the second threshold value R2. For example, it is easy to avoid overflow of the liquid storage section 40 in the transfer mode.

The transfer mode may be executed during printing or cleaning.

The liquid accommodation body 30 may be replaced during printing or cleaning.

The liquid ejection device 11 is not limited to a line-type printer, and may be a serial-type printer.

The liquid ejection device 11 may be a liquid ejection device that ejects a liquid other than ink. The state of the liquid that is ejected from the liquid ejection device in the form of a minute amount of liquid droplets includes a granular shape, a tear shape, and a shape with a thread-like tail. Here, the liquid may be any material that can be ejected from the liquid ejection device. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include ink as described in the above embodiment and liquid crystal. Here, ink encompasses various liquid compositions such as general water-based ink, oil-based ink, gel ink, and hot-melt ink. As a specific example of the liquid ejection device, there is a device that ejects a liquid containing, in a dispersed or dissolved form, a material such as an electrode material or a color material used for manufacturing a liquid crystal display, an electroluminescence display, a surface emitting display, a color filter, or the like. The liquid ejection device may be a device that ejects a bio-organic substance used for manufacturing a biochip, a device that is used as a precision pipette and that ejects a liquid serving as a sample, a textile printing device, a micro dispenser, or the like. The liquid ejection device may be a device that ejects lubricating oil in a pinpoint manner to precision machinery such as watches or cameras, or a device that ejects a transparent resin liquid, such as an ultraviolet curable resin, onto a substrate to form micro hemispherical lenses, optical lenses, or the like used in optical communication elements. The liquid ejection device may be a device for ejecting an etching solution such as an acid or an alkali for etching a substrate or the like.

### Definitions

As used herein, the expression “at least one” means “one or more” of the desired selection options. As an example, the phrase “at least one” as used herein means “only one selection option” or “both of two selection options” if the number of selection options is two. As another example, the expression “at least one” as used herein means “only one selection option”, “a combination of two optional selection options”, or “a combination of three or more optional selection options” when the number of selection options is three or more.

### Notes

Hereinafter, technical ideas grasped from the above-described embodiment and modifications, and operational effects thereof will be described.

[1] A liquid ejection device includes: a liquid ejection section configured to eject liquid; a liquid storage section configured to store liquid to be supplied to the liquid ejection section; a mount section on which a liquid accommodation body that contains liquid is mounted; a transfer section that transfers the liquid from the liquid accommodation body to the liquid storage section via the mount section; and a control section, wherein the control section is configured to execute a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and re-execute the transfer mode when, after the transfer mode has been executed and before the liquid accommodation body is replaced, the second remaining amount becomes equal to or less than a third threshold value, which is smaller than the second threshold value.

According to this configuration, when the second remaining amount of the liquid storage section becomes small after the transfer mode is executed, the transfer mode is executed again to transfer the liquid to the liquid storage section. The liquid that is not completely fed in one transfer mode and remains in the liquid accommodation body can be reduced by further transfer. The amount of liquid remaining in the liquid accommodation body at the time of replacement can be further reduced. Therefore, by reducing the liquid remaining when the liquid accommodation body is replaced, it is possible to suppress waste of the liquid.

[2] The liquid ejection device according to [1] further includes a detection section that detects that the first remaining amount in the liquid accommodation body has reached an end state, wherein the control section may be configured to if, after execution of the transfer mode, it is detected that the first remaining amount has reached the end state, not re-execute the transfer mode and if, after execution of the transfer mode, it is not detected that the first remaining amount has reached an end state, re-execute the transfer mode.

According to this configuration, when the first remaining amount is end state by the execution of the transfer mode, it is not necessary to execute the transfer mode again. Therefore, it is possible to avoid unnecessary execution of the transfer mode. For example, delays caused by unnecessary postponement can be avoided, such as delays in starting the replacement of liquid accommodation body or the commencement of printing.

[3] The liquid ejection device according to [1] or [2] may further include a sensing section configured to physically detect that the second remaining amount has reached the second threshold value. According to this configuration, the remaining amount can be reliably managed because the remaining amount is physically detected.

[4] The liquid ejection device according to [3] may be such that the sensing section also serves as an error sensing section that detects, as an error, that the second remaining amount has reached the second threshold value and the control section is configured to output the error when, regardless of execution of the transfer mode, the sensing section detects that the second remaining amount has reached the second threshold value and not output the error when the sensing section detects that the second remaining amount has reached the second threshold value due to the execution of the transfer mode. According to this configuration, in the transfer mode, when the second remaining amount becomes the second threshold value, an error is not output, and thus, it is possible to suppress confusion of the user.

[5] In the liquid ejection device according to any one of [1] to [4], the control section includes a first acquisition section that acquires the first remaining amount as a first estimated remaining amount and a second acquisition section that acquires the second remaining amount as a second estimated remaining amount and when the transfer mode is executed, the control section may decrease the first estimated remaining amount by the estimated amount of liquid transferred in the transfer mode and also may increase the second estimated remaining amount. According to this configuration, it is possible to suppress the occurrence of a difference between the actual remaining amount and the estimated remaining amount. Therefore, the amount of the usable liquid can be appropriately managed.

[6] The liquid ejection device according to [5] may further include, a display section configured to, after the transfer mode is executed, display information including at least one of the first estimated remaining amount, the second estimated remaining amount, or an estimated usable amount calculated by adding the first estimated remaining amount and the second estimated remaining amount. According to this configuration, the user can individually set the display setting, and thus the usability can be improved.

[7] The liquid ejection device according to [6] may further include an operation section operated when at least one of selection options displayed on the display section is selected and a setting section configured to receive and set at least one of the first estimated remaining amount, the second estimated remaining amount, and the estimated usable amount for display, based on a selection made through operation of the operation section. According to this configuration, the user can individually set the display setting, and thus the usability can be improved.

[8] The liquid ejection device according to any one of [1] to [7] may further include a notification section, wherein the control section may be configured to cause the notification section to notify information prompting replacement of the liquid accommodation body when the first remaining amount becomes equal to or less than a first threshold value. According to this configuration, the user can know the replacement timing of the liquid accommodation body.

[9] The liquid ejection device according to any one of [1] to [8] may further include a liquid replenishment section that replenishes the liquid storage section with the liquid from the liquid accommodation body via the mount section when a liquid level of the liquid storage section becomes equal to or lower than a reference liquid level, wherein the transfer section may transfer the liquid by causing the liquid replenishment section to replenish the liquid even when the liquid level of the liquid storage section is not equal to or less than the reference liquid level. According to this configuration, the liquid can be transported using the liquid replenishment section.

[10] In the liquid ejection device according to any one of [1] to [8], the liquid ejection device according to claim 1 may further include a liquid replenishment section that replenishes the liquid storage section with the liquid from the liquid accommodation body via the mount section when a liquid level of the liquid storage section becomes equal to or lower than a reference liquid level, wherein the transfer section may transfer the liquid from the liquid accommodation body to the liquid storage section via the mount section by adjusting air pressure in the liquid storage section to lower the liquid level to the reference liquid level or lower. According to this configuration, the liquid can be transferred using the liquid replenishment section by setting the liquid level in the liquid storage section to be equal to or lower than the reference liquid level.

[11] In the liquid ejection device according to any one of [1] to [8], the liquid storage section includes a first storage chamber configured to store the liquid supplied from the liquid accommodation body via the mount section, a lead out flow path having one end connected to the first storage chamber and configured to lead out the liquid in the first storage chamber, a second storage chamber connected to an other end of the lead out flow path and configured to store the liquid supplied from the first storage chamber, and a one-way valve configured to regulate a direction in which the liquid flows through the lead out flow path in one direction from the first storage chamber toward the second storage chamber, the liquid ejection device further comprises a liquid replenishment section that replenishes the liquid storage section with the liquid from the liquid accommodation body via the mount section when a liquid level in the first storage chamber becomes equal to or lower than a reference liquid level, the transfer section includes a decompression section configured to decompress the second storage chamber, a first atmosphere opening section configured to open the inside of the first storage chamber to atmosphere, and a second atmosphere opening section configured to open the inside of the second storage chamber to atmosphere, and the control section may be configured to execute the transfer mode by opening the inside of the second storage chamber to atmosphere after causing the transfer section to reduce pressure inside the second storage chamber to make the liquid level of the first storage chamber equal to or lower than the reference liquid level. According to this configuration, even if the liquid replenishment section does not have a liquid transfer means such as a pump, the transfer mode can be executed by applying reduced pressure. This allows for a simplified flow path structure while suppressing waste caused by unused liquid remaining in the liquid accommodation body.

[12] In the liquid ejection device according to any one of [1] to [8], the liquid storage section includes a first storage chamber configured to store the liquid supplied from the liquid accommodation body via the mount section, a lead out flow path having one end connected to the first storage chamber and configured to lead out the liquid in the first storage chamber, a second storage chamber connected to an other end of the lead out flow path and configured to store the liquid supplied from the first storage chamber, and a one-way valve configured to regulate a direction in which the liquid flows through the lead out flow path in one direction from the first storage chamber toward the second storage chamber, a liquid replenishment section that replenishes the first storage chamber with the liquid from the liquid accommodation body via the mount section when a liquid level in the first storage chamber becomes equal to or lower than a reference liquid level, the transfer section includes a pressurizing section that pressurizes at least the first storage chamber amongst the first storage chamber and the second storage chamber, a first atmosphere opening section configured to open the inside of the first storage chamber to atmosphere, and a second atmosphere opening section configured to open the inside of the second storage chamber to atmosphere, and the control section may execute the transfer mode by causing the transfer section to execute pressurization inside at least the first storage chamber to set the liquid level of the first storage chamber to be equal to or lower than the reference liquid level and then opening at least the pressurized first storage chamber to atmosphere.

According to this configuration, even if the liquid replenishment section does not include a liquid transfer means such as a pump, the transfer mode can be executed by pressurizing the first storage chamber. This allows for a simplified flow path structure while suppressing waste caused by unused liquid remaining in the liquid accommodation body.

[13] The liquid ejection device according to any one of [1] to [12] may include a supply flow path that supplies the liquid from the liquid storage section toward the liquid ejection section and a recovery flow path that recovers the liquid from the liquid ejection section into the liquid storage section. According to this configuration, while suppressing the thickening of the liquid and collecting foreign matters such as bubbles in liquid through liquid circulation, the long flow path required for liquid circulation allows the device side to retain a larger amount of liquid.

[14] A control method of a liquid ejection device, the device includes a liquid ejection section configured to eject liquid; a liquid storage section configured to store liquid to be supplied to the liquid ejection section; a mount section on which a liquid accommodation body that contains liquid is mounted; a transfer section that transfers the liquid from the liquid accommodation body to the liquid storage section via the mount section, the control method of a liquid ejection device including: execute a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and re-execute the transfer mode when, after the transfer mode has been executed and before the liquid accommodation body is replaced, the second remaining amount becomes equal to or less than a third threshold value, which is smaller than the second threshold value.

According to this method, when the second remaining amount of the liquid storage section decreases after the execution of the transfer mode, the transfer mode is executed again, and thus the transfer of the liquid is repeatedly performed. Therefore, by reducing the liquid remaining when the liquid accommodation body is replaced, it is possible to suppress waste of the liquid.

What is claimed is:

1. A liquid ejection device comprising:
a liquid ejection section configured to eject liquid;
a liquid storage section configured to store liquid to be supplied to the liquid ejection section;
a mount section on which a liquid accommodation body that contains liquid is mounted;
a transfer section that transfers the liquid from the liquid accommodation body to the liquid storage section via the mount section; and
a control section, wherein
the control section is configured to
execute a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and
re-execute the transfer mode when, after the transfer mode has been executed and before the liquid accommodation body is replaced, the second remaining amount becomes equal to or less than a third threshold value, which is smaller than the second threshold value.

2. The liquid ejection device according to claim 1, further comprising:
a detection section that detects that the first remaining amount in the liquid accommodation body has reached an end state, wherein
the control section is configured to
if, after execution of the transfer mode, it is detected that the first remaining amount has reached the end state, not re-execute the transfer mode and
if, after execution of the transfer mode, it is not detected that the first remaining amount has reached an end state, re-execute the transfer mode.

3. The liquid ejection device according to claim 1, further comprising:
a sensing section configured to physically detect that the second remaining amount has reached the second threshold value.

4. The liquid ejection device according to claim 3, wherein
the sensing section also serves as an error sensing section that detects, as an error, that the second remaining amount has reached the second threshold value and
the control section is configured to
output the error when, regardless of execution of the transfer mode, the sensing section detects that the second remaining amount has reached the second threshold value and
not output the error when the sensing section detects that the second remaining amount has reached the second threshold value due to the execution of the transfer mode.

5. The liquid ejection device according to claim 1, wherein
the control section includes
a first acquisition section that acquires the first remaining amount as a first estimated remaining amount and
a second acquisition section that acquires the second remaining amount as a second estimated remaining amount and
when the transfer mode is executed, the control section decreases the first estimated remaining amount by the estimated amount of liquid transferred in the transfer mode and also increases the second estimated remaining amount.

6. The liquid ejection device according to claim 5, further comprising:
a display section configured to, after the transfer mode is executed, display information including
at least one of the first estimated remaining amount, the second estimated remaining amount, or an estimated usable amount calculated by adding the first estimated remaining amount and the second estimated remaining amount.

7. The liquid ejection device according to claim 6, further comprising:
an operation section operated when at least one of selection options displayed on the display section is selected and
a setting section configured to receive and set at least one of the first estimated remaining amount, the second estimated remaining amount, and the estimated usable amount for display, based on a selection made through operation of the operation section.

8. The liquid ejection device according to claim 1, further comprising:
a notification section, wherein
the control section is configured to cause the notification section to notify information prompting replacement of the liquid accommodation body when the first remaining amount becomes equal to or less than a first threshold value.

9. The liquid ejection device according to claim 1, further comprising:
a liquid replenishment section that replenishes the liquid storage section with the liquid from the liquid accommodation body via the mount section when a liquid level of the liquid storage section becomes equal to or lower than a reference liquid level, wherein
the transfer section transfers the liquid by causing the liquid replenishment section to replenish the liquid even when the liquid level of the liquid storage section is not equal to or less than the reference liquid level.

10. The liquid ejection device according to claim 1, further comprising:
a liquid replenishment section that replenishes the liquid storage section with the liquid from the liquid accommodation body via the mount section when a liquid level of the liquid storage section becomes equal to or lower than a reference liquid level, wherein
the transfer section transfers the liquid from the liquid accommodation body to the liquid storage section via the mount section by adjusting air pressure in the liquid storage section to lower the liquid level to the reference liquid level or lower.

11. The liquid ejection device according to claim 1, wherein
the liquid storage section includes
a first storage chamber configured to store the liquid supplied from the liquid accommodation body via the mount section,
a lead out flow path having one end connected to the first storage chamber and configured to lead out the liquid in the first storage chamber,
a second storage chamber connected to an other end of the lead out flow path and configured to store the liquid supplied from the first storage chamber, and
a one-way valve configured to regulate a direction in which the liquid flows through the lead out flow path in one direction from the first storage chamber toward the second storage chamber,
the liquid ejection device further comprises
a liquid replenishment section that replenishes the liquid storage section with the liquid from the liquid accommodation body via the mount section when a liquid level in the first storage chamber becomes equal to or lower than a reference liquid level,
the transfer section includes
a decompression section configured to decompress the second storage chamber,
a first atmosphere opening section configured to open inside of the first storage chamber to atmosphere, and
a second atmosphere opening section configured to open the inside of the second storage chamber to atmosphere, and
the control section is configured to execute the transfer mode by opening the inside of the second storage chamber to atmosphere after causing the transfer section to reduce pressure inside the second storage chamber to make the liquid level of the first storage chamber equal to or lower than the reference liquid level.

12. The liquid ejection device according to claim 1, wherein
the liquid storage section includes
a first storage chamber configured to store the liquid supplied from the liquid accommodation body via the mount section,
a lead out flow path having one end connected to the first storage chamber and configured to lead out the liquid in the first storage chamber,
a second storage chamber connected to an other end of the lead out flow path and configured to store the liquid supplied from the first storage chamber, and
a one-way valve configured to regulate a direction in which the liquid flows through the lead out flow path in one direction from the first storage chamber toward the second storage chamber,
the liquid ejection device further comprises
a liquid replenishment section that replenishes the first storage chamber with the liquid from the liquid accommodation body via the mount section when a liquid level in the first storage chamber becomes equal to or lower than a reference liquid level,
the transfer section includes
a pressurizing section that pressurizes at least the first storage chamber amongst the first storage chamber and the second storage chamber,
a first atmosphere opening section configured to open inside of the first storage chamber to atmosphere, and
a second atmosphere opening section configured to open the inside of the second storage chamber to atmosphere, and
the control section executes the transfer mode by causing the transfer section to execute pressurization inside at least the first storage chamber to set the liquid level of the first storage chamber to be equal to or lower than the reference liquid level and then opening at least the pressurized first storage chamber to atmosphere.

13. The liquid ejection device according to claim 1, further comprising:
a supply flow path that supplies the liquid from the liquid storage section toward the liquid ejection section and
a recovery flow path that recovers the liquid from the liquid ejection section into the liquid storage section.

14. A method of controlling a liquid ejection device, the liquid ejection device including
a liquid ejection section configured to eject liquid;
a liquid storage section configured to store liquid to be supplied to the liquid ejection section;
a mount section on which a liquid accommodation body that contains liquid is mounted; and
a transfer section that transfers the liquid from the liquid accommodation body to the liquid storage section via the mount section, the method comprising:
execute a transfer mode when a first remaining amount, which is the amount of liquid in the liquid accommodation body, becomes equal to or less than a first threshold value, the transfer mode being a mode in which the liquid in the liquid accommodation body is transferred to the liquid storage section until a second remaining amount, which is the amount of liquid in the liquid storage section, reaches a second threshold value and
re-execute the transfer mode when, after the transfer mode has been executed and before the liquid accommodation body is replaced, the second remaining amount becomes equal to or less than a third threshold value, which is smaller than the second threshold value.
